(19) United States
(12) Patent Application Publication
(10) Pub. No.: US 2026/0167784 A1
(43) Pub. Date: Jun. 18, 2026

(54) HALOGENATED RESIN COMPOSITION

(71) Applicant: KAO CORPORATION, Tokyo (JP)

(72) Inventors: Osamu TAKIGUCHI, Wakayama-shi (JP); Satoshi WADA, Wakayama-shi (JP)

(73) Assignee: KAO CORPORATION, Tokyo (JP)

(21) Appl. No.: 18/707,831

(22) PCT Filed: Oct. 17, 2022
(86) PCT No.: PCT/JP2022/038608

§ 371 Date: May 6, 2024

(30) Foreign Application Priority Data
Nov. 10, 2021 (JP) 2021-183479

(51) Int. Cl. C08J 3/18; C08J 3/20; C08K 3/26; C08K 5/101; C08K 5/11

(52) U.S. Cl. CPC C08J 3/18; C08J 3/20; C08K 3/26; C08K 5/101; C08K 5/11; C08J 2311/00; C08J 2327/06; C08J 2327/08; C08J 2333/10; C08K 2003/265

(57) ABSTRACT

The present invention relates to a halogen-based resin composition containing a plasticizer, a polymer dispersant, a basic inorganic filler and a halogen-based resin, in which the polymer dispersant contains a carboxy group-containing constitutional unit and a hydrophobic group-containing constitutional unit; a degree of neutralization of the polymer dispersant is not more than 30 mol %; and a weight-average molecular weight (Mw) of the polymer dispersant is not less than 4,000 and not more than 200,000.

### FIELD OF THE INVENTION

The present invention relates to a halogen-based resin composition.

### BACKGROUND OF THE INVENTION

A halogen-based resin, such as a vinyl chloride resin (PVC), etc., is an important resin that has been used as a general-purpose polymer in various application fields. For example, the PVC has been used in the application fields including interior materials for housing, such as wallpapers, etc.; versatile goods, such as toys, etc.; automotive materials, such as sealing materials, etc.; and the like.

When using the halogen-based resin, a plasticizer, a diluent, a viscosity reducer, a filler, such as calcium carbonate, etc., a pigment, a fire retardant, a foaming agent, a stabilizer and the like have been compounded, for example, in a resin powder of the halogen-based resin, to prepare a halogen-based resin composition. However, many of the conventional halogen-based resin compositions often tend to be highly viscous, and therefore tend suffer from such a problem that it is difficult or impossible to subject such halogen-based resin compositions to proper processing steps.

As the method of reducing a viscosity of the halogen-based resin composition, it is conventionally known that a hydrocarbon-based solvent, such as mineral spirit, an alkyl benzene, paraffin, etc., or an anionic surfactant, a polyoxyethylene alkyl phenol ether, polyethylene glycol, a glycerin alkyl ester, etc., are used as a diluent or a viscosity reducer. These diluents or viscosity reducers are added to the halogen-based resin after production thereof or the halogen-based resin composition upon preparation thereof. However, these diluents or viscosity reducers have failed to impart sufficient viscosity reducing effects to the resulting halogen-based resin composition, in particular, the effects of reducing the viscosity of the halogen-based resin composition tend to be insufficient in the case where the fillers, such as calcium carbonate, etc., are compounded in the halogen-based resin composition.

JP H7-504846A (Patent Literature 1) discloses a composition that contains an inorganic solid on the surface of which a surfactant that is characterized by a plurality of addition-copolymer chains, characterized, on each chain, by an average of at least 0.5 adsorptive or chemisorptive group and at least one polyether residue, and characterized, between the chains, by at least one divalent polyether residue is adsorbed, and a plasticizer-containing polymer.

### SUMMARY OF THE INVENTION

The present invention relates to a halogen-based resin composition containing a plasticizer, a polymer dispersant, a basic inorganic filler and a halogen-based resin, in which:
the polymer dispersant contains a carboxy group-containing constitutional unit and a hydrophobic group-containing constitutional unit;
a degree of neutralization of the polymer dispersant is not more than 30 mol %; and
a weight-average molecular weight (Mw) of the polymer dispersant is not less than 4,000 and not more than 200,000.

### DETAILED DESCRIPTION OF THE INVENTION

In the composition described in the aforementioned Patent Literature 1, it is required that in order to adsorb the surfactant on the surface of the inorganic solid, the surfactant is neutralized with an alkali to dissolve it in water, and further a precipitate formed by subjecting a dispersion containing the surfactant and the inorganic solid to precipitation is dried. For this reason, in the composition described in the Patent Literature 1, only a water-soluble surfactant can be used, and therefore there tends to occur such a problem that the surfactant usable therein is restricted.

The present invention relates to a halogen-based resin composition that is improved in processability by reducing a slurry viscosity thereof.

The present inventors have found that the aforementioned conventional problems can be solved by a halogen-based resin composition containing a plasticizer, a polymer dispersant, a basic inorganic filler and a halogen-based resin.

That is, the present invention relates to a halogen-based resin composition containing a plasticizer, a polymer dispersant, a basic inorganic filler and a halogen-based resin, in which:
the polymer dispersant contains a carboxy group-containing constitutional unit and a hydrophobic group-containing constitutional unit;
a degree of neutralization of the polymer dispersant is not more than 30 mol %; and
a weight-average molecular weight (Mw) of the polymer dispersant is not less than 4,000 and not more than 200,000.

In accordance with the present invention, there is provided a halogen-based resin composition that is improved in processability by reducing a slurry viscosity thereof

### [Halogen-Based Resin Composition]

The halogen-based resin composition of the present invention contains a plasticizer, a polymer dispersant, a basic inorganic filler and a halogen-based resin, in which the polymer dispersant contains a carboxy group-containing constitutional unit and a hydrophobic group-containing constitutional unit; a degree of neutralization of the polymer dispersant is not more than 30 mol %; and a weight-average molecular weight (Mw) of the polymer dispersant is not less than 4,000 and not more than 200,000.

The halogen-based resin composition of the present invention is capable of showing such an advantageous effect that the composition has a low slurry viscosity and is therefore excellent in processability. The reason why the above advantageous effect can be attained by the present invention is considered as follow though it is not necessarily clearly determined yet.

In the halogen-based resin composition containing the plasticizer, the basic inorganic filler exhibits hydrophilic properties and is therefore flocculated in the plasticizer to form a network structure, so that the basic inorganic filler is stabilized. However, the basic inorganic filler that is flocculated to form a network structure tends to act to increase a viscosity of the halogen-based resin composition.

In this case, it is considered that the polymer dispersant contained in the halogen-based resin composition of the present invention is adsorbed onto the surface of the basic inorganic filler to render the surface of the basic inorganic filler hydrophobic, so that the basic inorganic filler can be prevented from being flocculated and forming a network structure in the resin composition, whereby it is possible to improve processability of the halogen-based resin composition by reducing a slurry viscosity thereof. In addition, in the case where the degree of neutralization of the polymer dispersant is not more than 50 mol %, the solubility of the polymer dispersant in the plasticizer is increased, so that the polymer dispersant is homogeneously adsorbed onto the basic inorganic filler. Therefore it is considered that the slurry viscosity of the resulting halogen-based resin composition is reduced. Furthermore, in the case where the weight-average molecular weight of the polymer dispersant lies within the predetermined range, the surface of the basic inorganic filler is efficiently hydrophobized. More concretely, it is considered that in the case where the weight-average molecular weight of the polymer dispersant is not less than 4,000, the polymer dispersant is prevented from being desorbed from the basic inorganic filler owing to multi-point adsorption thereof onto the basic inorganic filler. Whereas, in the case where the weight-average molecular weight of the polymer dispersant is not more than 200,000, the solubility of the polymer dispersant in the plasticizer becomes high, and further the diffusion rate of the polymer dispersant is increased, so that the polymer dispersant can be more uniformly adsorbed onto the basic inorganic filler when allowing the polymer dispersant to act on the basic inorganic filler. As a result, it is considered that the resulting halogen-based resin composition is excellent in flexing properties even under low temperature conditions.

The slurry viscosity of the halogen-based resin composition of the present invention as measured at 25° C. is preferably not more than 23 Pa·s, more preferably not more than 20 Pa·s and even more preferably not more than 17 Pa·s from the viewpoint of allowing the halogen-based resin composition to exhibit excellent low-temperature flex resistance and processability.

The slurry viscosity may be measured by the method described in Examples below.

The shape of the halogen-based resin composition is not particularly limited. The halogen-based resin composition may be used, for example, in the form of a mixed powder, pellets or a paste.

### [Polymer Dispersant]

In the present invention, the polymer dispersant contains a carboxy group-containing constitutional unit from the viewpoint of facilitating adsorption of the polymer dispersant onto the basic inorganic filler, and a hydrophobic group-containing constitutional unit from the viewpoint of facilitating dissolution or dispersion of the polymer dispersant in the plasticizer.

As the carboxy group-containing constitutional unit, there may be mentioned, for example, constitutional units derived from α,β-unsaturated carboxylic acids, such as (meth)acrylic acid, fumaric acid, maleic acid, crotonic acid, itaconic acid and the like. Among these constitutional units, preferred are the constitutional units derived from (meth)acrylic acid, and more preferred is the constitutional unit derived from methacrylic acid.

Incidentally, the term “(meth)acrylic acid” as used in the present specification means at least one compound selected from the group consisting of acrylic acid and methacrylic acid, and the term “(meth)acrylate” as used in the present specification means at least one compound selected from the group consisting of an acrylate and a methacrylate.

As the hydrophobic group-containing constitutional unit, from the viewpoint of facilitating dissolution or dispersion of the polymer dispersant in the plasticizer, there may be mentioned constitutional units derived from esters of the aforementioned α,β-unsaturated carboxylic acids, amides of the aforementioned α,β-unsaturated carboxylic acids, styrene-based compounds, C₃ to C₁₀ linear or branched alkenes, and the like.

Meanwhile, in the case where the α,β-unsaturated carboxylic acid esters and the α,β-unsaturated carboxylic acid amides are in the form of an ester of a polycarboxylic acid and an amide of a polycarboxylic acid, respectively, and contain at least one carboxy group, the ester and amide of the polycarboxylic acid respectively constitute both of the carboxy group-containing constitutional unit and the hydrophobic group-containing constitutional unit.

As the α,β-unsaturated carboxylic acid esters, from the viewpoint of ensuring good availability, there may be mentioned, for example, esters of an α,β-unsaturated carboxylic acid and a linear or branched alkyl alcohol. The number of carbon atoms contained in the linear or branched alkyl alcohol is preferably not less than 1, more preferably not less than 3 and even more preferably not less than 5, and is also preferably not more than 30, more preferably not more than 25 and even more preferably not more than 20, from the viewpoint of improving compatibility of the polymer dispersant with the plasticizer. More specifically, the number of carbon atoms contained in the linear or branched alkyl alcohol is preferably not less than 1 and not more than 30, more preferably not less than 3 and not more than 25, and even more preferably not less than 5 and not more than 20.

As the aforementioned esters of the α,β-unsaturated carboxylic acid and the linear or branched alkyl alcohol, from the viewpoint of improving low-temperature flex resistance of the halogen-based resin composition, and improving processability of the halogen-based resin composition owing to reduction of a slurry viscosity of the halogen-based resin composition, preferred are 2-ethylhexyl (meth)acrylate, lauryl (meth)acrylate and stearyl (meth)acrylate.

In addition, the α,β-unsaturated carboxylic acid esters may be in the form of an ester of a polyalkylene glycol having not less than 1 and not more than 30 repeating units which contains a medium-chain or long-chain alkyl group at a one terminal end thereof, and an α,β-unsaturated carboxylic acid, from the viewpoint of further enhancing solubility of the polymer dispersant in the plasticizer. The number of carbon atoms contained in the medium-chain or long-chain alkyl group is preferably not less than 4, more preferably not less than 6 and even more preferably not less than 8, and is also preferably not more than 24, more preferably not more than 18 and even more preferably not more than 16, from the viewpoint of improving compatibility of the polymer dispersant with the plasticizer. More specifically, the number of carbon atoms contained in the medium-chain or long-chain alkyl group is preferably not less than 4 and not more than 24, more preferably not less than 6 and not more than 18, and even more preferably not less than 8 and not more than 16.

As the aforementioned ester of the polyalkylene glycol and the α,β-unsaturated carboxylic acid, from the viewpoint of improving low-temperature flex resistance of the halogen-based resin composition, and improving processability of the halogen-based resin composition owing to reduction of a slurry viscosity of the halogen-based resin composition, preferred are stearoxypolyethylene glycol mono(meth)acrylate, lauroxypolyethylene glycol mono(meth)acrylate and 2-ethylhexyloxypropylene glycol polyethylene glycol mono(meth)acrylate.

As the α,β-unsaturated carboxylic acid amides, from the viewpoint of facilitating introduction thereof into a molecular structure of the polymer dispersant, there may be mentioned, for example, amides of an α,β-unsaturated carboxylic acid and a linear or branched primary alkyl amine. The number of carbon atoms contained in the linear or branched primary alkyl amine is preferably not less than 4, more preferably not less than 6 and even more preferably not less than 8, and is also preferably not more than 30, more preferably not more than 25 and even more preferably not more than 20, from the viewpoint of improving compatibility of the polymer dispersant with the plasticizer. More specifically, the number of carbon atoms contained in the linear or branched primary alkyl amine is preferably not less than 4 and not more than 30, more preferably not less than 6 and not more than 25, and even more preferably not less than 8 and not more than 20.

As the styrene compounds, from the viewpoint of ensuring good availability, there may be mentioned, for example, styrene, α-methyl styrene and the like.

As the C₃ to C₁₀ linear or branched alkenes, from the viewpoint of facilitating copolymerization thereof with maleic anhydride, there may be mentioned, for example, isoprene, butadiene, isobutylene, diisobutylene and the like.

Among the aforementioned hydrophobic group-containing constitutional units, from the viewpoint of improving low-temperature flex resistance of the halogen-based resin composition, and further improving reduction of a slurry viscosity of the halogen-based resin composition, preferred are constitutional units derived from at least one compound selected from the group consisting of stearyl (meth)acrylate, 2-ethylhexyl (meth)acrylate, lauryl (meth)acrylate, stearoxypolyethylene glycol mono(meth)acrylate, lauroxypolyethylene glycol (meth)acrylate, 2-ethylhexyloxypolypropylene glycol polyethylene glycol (meth)acrylate and diisobutylene.

The polymer dispersant may contain a hydrophilic group-containing constitutional unit from the viewpoint of well controlling a hydrophile-lipophile balance of the resin composition. However, in the present invention, the hydrophilic group-containing constitutional unit does not include the carboxy group-containing constitutional unit. Examples of the hydrophilic group-containing constitutional unit include a constitutional unit derived from a compound containing an acid group, such as a sulfonic acid group, a sulfinic acid group, a sulfuric acid group, a sulfurous acid group, a phosphoric acid group and a phosphorous acid group, a constitutional unit derived from (meth)acrylamide, dimethyl (meth)acrylamide or acrylonitrile, a constitutional unit derived from an α,β-unsaturated carboxylic acid alkyloxypolyalkylene glycol ester, and the like.

The polymer dispersant preferably contains the constitutional unit derived from the α,β-unsaturated carboxylic acid alkyloxypolyalkylene glycol ester, more preferably a constitutional unit derived from an α,β-unsaturated carboxylic acid alkyloxy-polyethylene glycol and/or -polypropylene glycol ester, and even more preferably a constitutional unit derived from an α,β-unsaturated carboxylic acid alkyloxypolyethylene glycol ester, from the viewpoint of facilitating designing of the hydrophile-lipophile balance of the resin composition.

The number of repeating units of an alkylene glycol moiety in the constitutional unit derived from the α,β-unsaturated carboxylic acid alkyloxypolyalkylene glycol ester is preferably not less than 2, more preferably not less than 4 and even more preferably not less than 9, and is also preferably not more than 60, more preferably not more than 55 and even more preferably not more than 45, from the viewpoint of adsorbing the polymer dispersant onto the basic inorganic filler and reducing a slurry viscosity of the halogen-based resin composition. More specifically, the number of repeating units of an alkylene glycol moiety in the constitutional unit derived from the α,β-unsaturated carboxylic acid alkyloxypolyalkylene glycol ester is preferably not less than 2 and not more than 60, more preferably not less than 4 and not more than 55, and even more preferably not less than 9 and not more than 45.

The aforementioned constitutional unit derived from the α,β-unsaturated carboxylic acid alkyloxypolyalkylene glycol ester is preferably a constitutional unit derived from methoxypolyethylene glycol monomethacrylate from the viewpoint of improving low-temperature flex resistance of the halogen-based resin composition and reducing a slurry viscosity of the halogen-based resin composition.

The content of the carboxy group-containing constitutional unit in the polymer dispersant, provided that the content of the whole constitutional units therein is 100% by mass, is preferably not less than 1% by mass, more preferably not less than 2% by mass, even more preferably not less than 3% by mass and further even more preferably not less than 5% by mass from the viewpoint of adsorbing the polymer dispersant onto the basic inorganic filler and reducing a slurry viscosity of the halogen-based resin composition, and is also preferably not more than 50% by mass, more preferably not more than 40% by mass, even more preferably not more than 30% by mass and further even more preferably not more than 20% by mass from the viewpoint of improving compatibility of the polymer dispersant with the plasticizer. More specifically, the content of the carboxy group-containing constitutional unit in the polymer dispersant, provided that the content of the whole constitutional units therein is 100% by mass, is preferably not less than 1% by mass and not more than 50% by mass, more preferably not less than 2% by mass and not more than 50% by mass, even more preferably not less than 2% by mass and not more than 40% by mass, further even more preferably not less than 2% by mass and not more than 30% by mass, still further even more preferably not less than 3% by mass and not more than 30% by mass, and yet still further even more preferably not less than 5% by mass and not more than 20% by mass.

The content of the hydrophobic group-containing constitutional unit in the polymer dispersant, provided that the content of the whole constitutional units therein is 100% by mass, is preferably not less than 5% by mass, more preferably not less than 10% by mass and even more preferably not less than 13% by mass from the viewpoint of improving compatibility of the polymer dispersant with the plasticizer, and is also preferably not more than 98% by mass, more preferably not more than 95% by mass and even more preferably not more than 93% by mass from the viewpoint of exerting no adverse influence on adsorption of the polymer dispersant onto the basic inorganic filler. More specifically, the content of the hydrophobic group-containing constitutional unit in the polymer dispersant, provided that the content of the whole constitutional units therein is 100% by mass, is preferably not less than 50% by mass and not more than 98% by mass, more preferably not less than 70% by mass and not more than 98% by mass, even more preferably not less than 70% by mass and not more than 95% by mass, and further even more preferably not less than 70% by mass and not more than 93% by mass.

The weight-average molecular weight of the polymer dispersant is preferably not less than 4,000, more preferably not less than 4,500 and even more preferably not less than 5,000 from the viewpoint of preventing the polymer dispersant from being desorbed from the basic inorganic filler, and is also preferably not more than 200,000, more preferably not more than 180,000, even more preferably not more than 170,000, further even more preferably not more than 150,000, still further even more preferably not more than 100,000, still further even more preferably not more than 70,000, still further even more preferably not more than 50,000, still further even more preferably not more than 30,000, and yet still further even more preferably not more than 20,000 from the viewpoint of efficiently adsorbing the polymer dispersant onto the basic inorganic filler. More specifically, the weight-average molecular weight of the polymer dispersant is preferably not less than 4,000 and not more than 200,000, more preferably not less than 4,000 and not more than 180,000, even more preferably not less than 4,000 and not more than 170,000, further even more preferably not less than 4,500 and not more than 150,000, still further even more preferably not less than 4,500 and not more than 120,000, still further even more preferably not less than 4,500 and not more than 100,000, still further even more preferably not less than 5,000 and not more than 70,000, still further even more preferably not less than 5,000 and not more than 50,000, still further even more preferably not less than 5,000 and not more than 30,000, and yet still further even more preferably not less than 5,000 and not more than 20,000.

The weight-average molecular weight may be measured by the method described in Examples below.

The acid value of the polymer dispersant is preferably not less than 30 mgKOH/g, more preferably not less than 40 mgKOH/g and even more preferably not less than 45 mgKOH/g from the viewpoint of adsorbing the polymer dispersant onto the basic inorganic filler and reducing a slurry viscosity of the halogen-based resin composition, and is also preferably not more than 150 mgKOH/g, more preferably not more than 130 mgKOH/g and even more preferably not more than 120 mgKOH/g from the viewpoint of improving compatibility of the polymer dispersant with the plasticizer. More specifically, the acid value of the polymer dispersant is preferably not less than 30 mgKOH/g and not more than 150 mgKOH/g, more preferably not less than 40 mgKOH/g and not more than 130 mgKOH/g, and even more preferably not less than 45 mgKOH/g and not more than 120 mgKOH/g.

The acid value of the polymer dispersant may be calculated from a mass ratio between the monomers constituting the polymer dispersant. In addition, the acid value of the polymer dispersant may also be determined by the method in which the polymer dispersant is dissolved in or swelled with an adequate solvent (e.g., methyl ethyl ketone), and then the resulting solution or swelled product is subjected to titration.

From the viewpoint of adsorbing the polymer dispersant onto the basic inorganic filler and reducing a slurry viscosity of the halogen-based resin composition, the degree of neutralization of the polymer dispersant is not more than 30 mol %. The degree of neutralization of the polymer dispersant is preferably not more than 25 mol % and more preferably not more than 15 mol %. It is even more preferred that the polymer dispersant be in an unneutralized state.

As the neutralizing agent for the polymer dispersant, from the viewpoint of ensuring good availability, there may be mentioned, for example, an alkali metal hydroxide, ammonia, an organic amine and the like. Examples of the alkali metal hydroxide include lithium hydroxide, sodium hydroxide, potassium hydroxide and cesium hydroxide. Examples of the organic amine include trimethylamine, ethylamine, diethylamine, triethylamine, triethanolamine and the like.

The mass ratio of the polymer dispersant to the basic inorganic filler (polymer dispersant/basic inorganic filler) in the halogen-based resin composition of the present invention is preferably not less than 0.0001, more preferably not less than 0.0005, even more preferably not less than 0.001 and further even more preferably not less than 0.002, and is also preferably not more than 10, more preferably not more than 5, even more preferably not more than 1, further even more preferably not more than 0.5, still further even more preferably not more than 0.1, still further even more preferably not more than 0.05, still further even more preferably not more than 0.03 and yet still further even more preferably not more than 0.01, from the viewpoint of adsorbing the polymer dispersant onto the basic inorganic filler, improving low-temperature flex resistance of the halogen-based resin composition, and improving processability of the halogen-based resin composition owing to reduction of a slurry viscosity of the halogen-based resin composition. More specifically, the mass ratio of the polymer dispersant to the basic inorganic filler in the halogen-based resin composition is preferably not less than 0.0001 and not more than 10, more preferably not less than 0.0001 and not more than 5, even more preferably not less than 0.0001 and not more than 1, further even more preferably not less than 0.0001 and not more than 0.5, still further even more preferably not less than 0.0001 and not more than 0.1, still further even more preferably not less than 0.0001 and not more than 0.05, still further even more preferably not less than 0.0001 and not more than 0.03, still further even more preferably not less than 0.0001 and not more than 0.01, still further even more preferably not less than 0.0005 and not more than 0.01, still further even more preferably not less than 0.001 and not more than 0.01, and yet still further even more preferably not less than 0.002 and not more than 0.01.

The content of the polymer dispersant in the halogen-based resin composition is preferably not less than 0.001% by mass and not more than 0.8% by mass on the basis of the halogen-based resin composition from the viewpoint of reducing a slurry viscosity of the halogen-based resin composition.

### (Method for Producing Polymer Dispersant)

The polymer dispersant may be produced by copolymerizing monomers, such as an anionic group-containing compound, a hydrophobic group-containing compound, a hydrophilic group-containing compound, etc., by conventionally known polymerization methods. As the polymerization methods, from the viewpoint of enabling production of the polymer dispersant using general-purpose facilities, preferred is a solution polymerization method.

The solvent used in the solution polymerization method is not particularly limited as long as the monomers can be dissolved therein. Examples of the preferred solvent include polar solvents, e.g., aromatic solvents, such as toluene, xylene, etc., aliphatic alcohols, ketones, ethers, esters and the like. Among these solvents, more preferred are toluene, methanol, ethanol, acetone, methyl ethyl ketone and the like, and even more preferred are toluene and ethanol. These solvents may be used alone or in the form of a mixture of any two or more thereof.

The polymerization may be carried out in the presence of a polymerization initiator or a polymerization chain transfer agent.

As the polymerization initiator, from the viewpoint of stably conducting the polymerization below a boiling point of the aforementioned solvent, there may be used conventionally known radical polymerization initiators, e.g., azo compounds, such as 2,2′-azobisisobutyronitrile, 2,2′-azobis(2,4-dimethylvaleronitrile), etc., organic peroxides, such as t-butyl peroxyoctoate, benzoyl peroxide, etc., and the like. The amount of the radical polymerization initiator used in the polymerization is preferably not less than 0.1 part by mass and more preferably not less than 0.5 part by mass, and is also preferably not more than 5 parts by mass and more preferably not more than 4 parts by mass, on the basis of 100 parts by mass of the mixture of the monomers. More specifically, the amount of the radical polymerization initiator used in the polymerization is preferably not less than 0.1 part by mass and not more than 5 parts by mass, and more preferably not less than 0.5 part by mass and not more than 4 parts by mass, on the basis of 100 parts by mass of the mixture of the monomers.

As the polymerization chain transfer agent, from the viewpoint of facilitating control of a molecular weight of the polymer dispersant, there may be used conventionally known polymerization chain transfer agents, e.g., mercaptans, such as octyl mercaptan, 2-mercaptoethanol, 3-mercapto-1,2-propanediol, mercaptopropionic acid, etc., thiuram disulfides, and the like.

In addition, the type of a polymerization chain of the monomers polymerized is not particularly limited, and may be any of a random type, a block type, a grafted type, etc.

The monomers may include a compound that contains two or more radical-polymerizable carbon-carbon double bonds (crosslinking agent) from the viewpoint of facilitating control of a molecular weight of the polymer dispersant. In the case where the monomers include the crosslinking agent, the content of the crosslinking agent in the whole monomers is preferably not more than 3 mol % from the viewpoint of preventing gelation of the reaction system. The content of the crosslinking agent in the mixture of the monomers is preferably not more than 2 mol % and more preferably not more than 1 mol %.

The preferred polymerization conditions may vary depending upon the kinds of polymerization initiators, monomers and solvents used in the polymerization, etc. From the viewpoint of enabling the polymerization using general-purpose facilities, in general, the polymerization temperature is preferably not lower than 30° C. and more preferably not lower than 50° C., and is also preferably not higher than 95° C. and more preferably not higher than 80° C. More specifically, the polymerization temperature is preferably not lower than 30° C. and not higher than 95° C., and more preferably not lower than 50° C. and not higher than 80° C. The polymerization time is preferably not shorter than 1 hour and more preferably not shorter than 2 hours, and is also preferably not longer than 20 hours and more preferably not longer than 10 hours. More specifically, the polymerization time is preferably not shorter than 1 hour and not longer than 20 hours, and more preferably not shorter than 2 hours and not longer than 10 hours. Furthermore, the polymerization is preferably conducted in a nitrogen gas atmosphere or an atmosphere of an inert gas such as argon, etc.

### [Halogen-Based Resin]

The halogen-based resin used in the present invention means a homopolymer or a copolymer of a halogen-containing monomer, or a polymer that is modified with a halogen. Specific examples of the halogen-based resin include at least one resin selected from the group consisting of a vinyl chloride resin, a vinylidene chloride resin, chlorinated polyethylene, chlorinated polypropylene, chloro-sulfonated polyethylene, a chloroprene rubber, and the like, from the viewpoint of ensuring good availability thereof. The halogen-based resin composition of the present invention preferably contains at least one resin selected from the group consisting of a vinyl chloride resin, a vinylidene chloride resin and a chloroprene rubber.

### (Vinyl Chloride Resin)

Examples of the vinyl chloride resin include a vinyl chloride homopolymer as well as a copolymer of vinyl chloride with a monomer copolymerizable with the vinyl chloride (hereinafter also referred to as a “vinyl chloride copolymer”), a graft copolymer obtained by graft-copolymerizing vinyl chloride to a polymer other than the aforementioned vinyl chloride copolymer, and the like.

The aforementioned monomer copolymerizable with vinyl chloride may include those monomers having a reactive double bond in a molecule thereof from the viewpoint of facilitating copolymerization of the monomer with vinyl chloride. Examples of the monomer copolymerizable with vinyl chloride include α-olefins, such as ethylene, propylene, butylene, etc.; vinyl esters, such as vinyl acetate, vinyl propionate, etc.; vinyl ethers, such as butyl vinyl ether, cetyl vinyl ether, etc.; esters of (meth)acrylic acid, such as methyl (meth)acrylate, ethyl (meth)acrylate, phenyl (meth)acrylate, etc.; aromatic vinyl compounds, such as styrene, «-methyl styrene, etc.; halogenated vinyl compounds, such as vinylidene chloride, vinyl fluoride, etc.; N-substituted maleimides, such as N-phenyl maleimide, N-cyclohexyl maleimide, etc.; and the like.

In addition, as the polymer other than the vinyl chloride copolymer, there may be used those polymers to which vinyl chloride is graft-copolymerizable from the viewpoint of ensuring good availability. Examples of the polymer other than the vinyl chloride copolymer include an ethylene-vinyl acetate copolymer, an ethylene-vinyl acetate-carbon monoxide copolymer, an ethylene-ethyl acrylate copolymer, an ethylene-ethyl acrylate-carbon monoxide copolymer, an ethylene-methyl methacrylate copolymer, an ethylene-propylene copolymer, an acrylonitrile-butadiene copolymer, a polyurethane and the like.

Of the aforementioned halogen-based resins, from the viewpoint of imparting good flexibility, etc., to the resin composition, preferred is at least one resin selected from the group consisting of a vinyl chloride-based resin, such as a vinyl chloride resin, an ethylene-vinyl chloride copolymer, a vinyl acetate-vinyl chloride copolymer, a polyurethane-grafted polyvinyl chloride copolymer, etc., a vinylidene chloride resin and a chloroprene rubber, more preferred is at least one resin selected from the group consisting of a vinyl chloride resin, a vinylidene chloride resin and a chloroprene rubber, and even more preferred is a vinyl chloride resin.

### [Plasticizer]

In the present invention, as the plasticizer, there may be used compounds that can be ordinarily used as a plasticizer for halogen-based resins. As such a plasticizer, from the viewpoint of attaining high compatibility of the plasticizer with the halogen-based resin, there may be mentioned those plasticizers whose SP value as measured by a Fedors method is preferably not less than 7.5 (cal/cm³)^{1/2}, more preferably not less than 8 (cal/cm³)^{1/2} and even more preferably not less than 8.5 (cal/cm³)^{1/2}, and is also preferably not more than 11.5 (cal/cm³)^{1/2}, more preferably not more than 11 (cal/cm³)^{1/2} and even more preferably not more than 10.5 (cal/cm³)^{1/2}. More specifically, the SP value of the plasticizer is preferably not less than 7.5 (cal/cm³)^{1/2} and not more than 11.5 (cal/cm³)^{1/2}, more preferably not less than 8 (cal/cm³)^{1/2} and not more than 11 (cal/cm³)^{1/2}, and even more preferably not less than 8.5 (cal/cm³)^{1/2} and not more than 10.5 (cal/cm³)^{1/2}.

Specific examples of the plasticizer include phthalic acid esters of a C₁ to C₁₃ alcohol, such as dioctyl phthalate (DOP), diisononyl phthalate (DINP), as well as dimethyl phthalate, diethyl phthalate, dibutyl phthalate, diundecyl phthalate, etc.; trimellitic acid esters of a C₆ to C₁₀ alcohol, such as tris(2-ethylhexyl) trimellitate, trioctyl trimellitate, tridecyl trimellitate, etc.; adipic acid esters; azelaic acid esters; sebacic acid esters; phosphoric acid esters; polyesters; epoxy-based compounds; fatty acid esters; pyromellitic acid esters; and the like, from the viewpoint of attaining high compatibility of the plasticizer with the halogen-based resin. These plasticizers may be used alone or in the form of a mixture of any two or more thereof. As the plasticizer, from the viewpoint of attaining high compatibility of the plasticizer with the halogen-based resin, preferred are phthalic acid esters or trimellitic acid esters of a C₁ to C₂₀ alcohol, more preferred are phthalic acid esters or trimellitic acid esters of a C₅ to C₁₈ alcohol, and even more preferred are phthalic acid esters or trimellitic acid esters of a C₈ to C₁₃ alcohol.

The content of the plasticizer in the halogen-based resin composition is preferably not less than 10 parts by mass, more preferably not less than 20 parts by mass and even more preferably not less than 30 parts by mass on the basis of 100 parts by mass of the halogen-based resin from the viewpoint of allowing the plasticizer to show good plasticizing effects for the halogen-based resin composition, and is also preferably not more than 170 parts by mass, more preferably not more than 160 parts by mass and even more preferably not more than 150 parts by mass on the basis of 100 parts by mass of the halogen-based resin from the viewpoint of improving low-temperature flex resistance of the halogen-based resin composition and improving processability of the halogen-based resin composition. More specifically, the content of the plasticizer in the halogen-based resin composition is preferably not less than 10 parts by mass and not more than 170 parts by mass, more preferably not less than 20 parts by mass and not more than 160 parts by mass, and even more preferably not less than 30 parts by mass and not more than 150 parts by mass, on the basis of 100 parts by mass of the halogen-based resin.

### [Basic Inorganic Filler]

Examples of the basic inorganic filler used in the present invention include calcium carbonate, talc, calcium silicate, alumina and the like. These basic inorganic fillers may be used alone or in the form of a mixture of any two or more thereof. The basic inorganic filler preferably contains calcium carbonate from the viewpoint of attaining good cost efficiency.

The content of the basic inorganic filler in the halogen-based resin composition is preferably not less than 1 part by mass, more preferably not less than 3 parts by mass and even more preferably not less than 5 parts by mass, and is also preferably not more than 150 parts by mass, more preferably not more than 140 parts by mass and even more preferably not more than 130 parts by mass, on the basis of 100 parts by mass of the halogen-based resin, from the viewpoint of reducing costs for the halogen-based resin composition. More specifically, the content of the basic inorganic filler in the halogen-based resin composition is preferably not less than 1 part by mass and not more than 150 parts by mass, more preferably not less than 3 parts by mass and not more than 140 parts by mass, and even more preferably not less than 5 parts by mass and not more than 130 parts by mass, on the basis of 100 parts by mass of the halogen-based resin.

### [Additives]

The halogen-based resin composition may further contain various additives, such as a stabilizer, a processing aid, a colorant, an antioxidant, an ultraviolet absorber, an antistatic agent, a lubricant, etc., if required, as long as the advantageous effects of the present invention are adversely affected by inclusion of these additives.

Examples of the stabilizer include metal soap compounds, such as lithium stearate, magnesium stearate, magnesium laurate, calcium ricinolate, calcium stearate, barium laurate, barium ricinolate, barium stearate, zinc octylate, zinc laurate, zinc ricinolate, zinc stearate, etc.; organotin-based compounds, such as dimethyl tin bis-2-ethylhexyl thioglycolate, dibutyl tin maleate, dibutyl tin bis(butyl maleate), dibutyl tin dilaurate, etc.; antimony mercaptide compounds; and the like. The content of the stabilizer in the halogen-based resin composition is from 0.1 to 20 parts by mass on the basis of 100 parts by mass of the halogen-based resin.

Examples of the processing aid include liquid paraffin, a polyethylene wax, stearic acid, stearamide, ethylene bis(stearamide), butyl stearate, calcium stearate and the like. The content of the processing aid in the halogen-based resin composition is from 0.1 to 20 parts by mass on the basis of 100 parts by mass of the halogen-based resin.

Examples of the colorant include carbon black, lead sulfide, white carbon, titanium white, lithopone, red iron oxide, antimony sulfide, chrome yellow, chrome green, cobalt blue, molybdenum orange and the like. The content of the colorant in the halogen-based resin composition is from 1 to 100 parts by mass on the basis of 100 parts by mass of the halogen-based resin.

Examples of the antioxidant include phenol-based compounds, such as 2,6-di-tert-butyl phenol, tetrakis [methylene-3-(3,5-tert-butyl-4-hydroxy phenol) propionate]methane, 2-hydroxy-4-methoxy benzophenone, etc.; sulfur-based compounds, such as alkyl disulfides, thiodipropionic acid esters, benzothiazole, etc.; phosphoric acid-based compounds, such as trisnonylphenyl phosphite, diphenyl isodecyl phosphite, triphenyl phosphite, tris(2,4-di-tert-butylphenyl) phosphite, etc.; organometallic-based compounds, such as zinc dialkyl dithiophosphates, zinc diaryl dithiophosphates, etc.; and the like. The content of the antioxidant in the halogen-based resin composition is from 0.2 to 20 parts by mass on the basis of 100 parts by mass of the halogen-based resin.

Examples of the ultraviolet absorber include salicylate-based compounds, such as phenyl salicylate, p-tert-butyl phenyl salicylate, etc.; benzophenone-based compounds, such as 2-hydroxy-4-n-octoxy benzophenone, 2-hydroxy-4-n-methoxy benzophenone, etc.; benzotriazole-based compounds, such as 5-methyl-1H-benzotriazole, 1-dioctyl aminomethyl benzotriazole, etc.; cyanoacrylate-based compounds; and the like. The content of the ultraviolet absorber in the halogen-based resin composition is from 0.1 to 10 parts by mass on the basis of 100 parts by mass of the halogen-based resin.

Examples of the antistatic agent include anionic antistatic agents, such as alkyl sulfonate-type antistatic agents, alkyl ether carboxylic acid-type antistatic agents and dialkyl sulfosuccinate-type antistatic agents; nonionic antistatic agents, such as polyethylene glycol derivatives, sorbitan derivatives, diethanol amine derivatives, etc.; cationic antistatic agents, such as quaternary ammonium salts, e.g., alkyl amide amine-type antistatic agents, alkyl dimethyl benzyl-type antistatic agents, etc., organic acid salts or hydrochloric acid salts, e.g., alkyl pyridinium-type antistatic agents, etc.; amphoteric antistatic agents, such as alkyl betaine-type antistatic agents, alkyl imidazoline-type antistatic agents, etc.; and the like. The content of the antistatic agent in the halogen-based resin composition is from 0.1 to 10 parts by mass on the basis of 100 parts by mass of the halogen-based resin.

Examples of the lubricant include silicones, liquid paraffin, a paraffin wax, fatty acids, such as stearic acid, lauric acid, etc., and metal salts thereof, fatty acid amides, fatty acid waxes, higher fatty acid waxes and the like. The content of the lubricant in the halogen-based resin composition is from 0.1 to 10 parts by mass on the basis of 100 parts by mass of the halogen-based resin.

### [Method for Producing Halogen-Based Resin Composition]

The method for producing the halogen-based resin composition of the present invention includes the step of mixing the polymer dispersant, the plasticizer, the basic inorganic filler and the halogen-based resin. Upon mixing the polymer dispersant, the plasticizer, the basic inorganic filler and the halogen-based resin, these components may be collectively added at one time, or may be mixed in sequential order.

The halogen-based resin composition may be obtained in the form of a mixed powder by mixing the polymer dispersant, the plasticizer, the basic inorganic filler and the halogen-based resin, and further, if required, various additives, with each other using a stirring device, for example, such as a mortar mixer, a Henschel mixer, a Banbury mixer, a ribbon blender, etc. In addition, the halogen-based resin composition may be obtained in the form of a mixed powder, pellets or a paste by subjecting the respective components to melt-molding using a kneading machine, such as a conical twin screw extruder, a parallel twin screw extruder, a single screw extruder, a co-kneader-type kneader, a roll kneader, etc.

The mixing and melt-molding conditions are not particularly limited as long as they may be used in ordinary methods for producing halogen-based resin compositions.

Upon mixing the polymer dispersant, the plasticizer, the basic inorganic filler and the halogen-based resin, from the viewpoint of allowing the polymer dispersant to efficiently act on the basic inorganic filler, it is preferred that the following step 1 be first carried out, and then the following steps 2 and 3 be further carried out. Any of the steps 2 and 3 may be carried out earlier, and the steps 2 and 3 may also be carried out at the same time. In addition, the polymer dispersant, the plasticizer, the basic inorganic filler and the halogen-based resin are preferably mixed by carrying out the following steps 1 to 3 in the sequential order. In the case where the additives are added to the halogen-based resin composition, the additives may be mixed therein along with the halogen-based resin either in the step 3 or subsequent to the step 3.
Step 1: mixing the polymer dispersant and the plasticizer with each other;
Step 2: further mixing the basic inorganic filler with a mixture obtained in the preceding step; and
Step 3: further mixing the halogen-based resin with a mixture obtained in the preceding step.

The mixed powder or pellets of the halogen-based resin composition can be formed into a desired shape by conventionally known methods, such as extrusion molding, injection molding, calender molding, press molding, blow molding, etc. In addition, the paste-like halogen-based resin composition can be formed into a desired shape by conventionally known methods, such as spread molding, dipping molding, gravure molding, screen processing, etc.

The halogen-based resin composition of the present invention is excellent in low-temperature flex resistance and processability, and is therefore useful as housing interior products, such as adhesives, sealants, paints, plastisol, foamed bodies, synthetic leather, pipes such as water pipes, etc., building materials, wall paper materials, floorings, floor covering materials, insulating materials, roof membrane materials, etc.; packaging materials, such as food packaging films, etc.; agricultural materials, such as agricultural films, etc.; automotive materials, such as sealing materials, undercoat materials, etc.; substrate protecting materials; cloth covering materials; sheathing materials for electric cables; various leather products; various foamed products; general-purpose hoses; gaskets; packing; boots; toys; food packaging materials; medical products, such as tubes, blood bags, etc.; and the like.

The present invention includes the following embodiments.
<1> A halogen-based resin composition containing a plasticizer, a polymer dispersant, a basic inorganic filler and a halogen-based resin, in which:
   the polymer dispersant contains a carboxy group-containing constitutional unit and a hydrophobic group-containing constitutional unit;
   a degree of neutralization of the polymer dispersant is not more than 30 mol %; and
   a weight-average molecular weight (Mw) of the polymer dispersant is not less than 4,000 and not more than 200,000.
<2> The halogen-based resin composition according to the aforementioned aspect <1>, wherein a content of the carboxy group-containing constitutional unit in the polymer dispersant is not less than 2% by mass and not more than 50% by mass on the basis of whole constitutional units in the polymer dispersant, and a content of the hydrophobic group-containing constitutional unit in the polymer dispersant is not less than 50% by mass and not more than 98% on the basis of the whole constitutional units in the polymer dispersant.
<3> The halogen-based resin composition according to the aforementioned aspect <1> or <2>, wherein the content of the carboxy group-containing constitutional unit in the polymer dispersant is not less than 2% by mass and not more than 30% by mass on the basis of the whole constitutional units in the polymer dispersant, and the content of the hydrophobic group-containing constitutional unit in the polymer dispersant is not less than 70% by mass and not more than 98% on the basis of the whole constitutional units in the polymer dispersant.
<4> The halogen-based resin composition according to any one of the aforementioned aspects <1> to <3>, wherein the polymer dispersant contains a constitutional unit derived from methacrylic acid as the carboxy group-containing constitutional unit.
<5> The halogen-based resin composition according to any one of the aforementioned aspects <1> to <4>, wherein the polymer dispersant contains at least one constitutional unit selected from the group consisting of those constitutional units derived from stearyl (meth)acrylate, lauryl (meth)acrylate, 2-ethylhexyl (meth)acrylate, stearoxypolyethylene glycol mono(meth)acrylate, lauroxypolyethylene glycol mono(meth)acrylate and 2-ethylhexyloxypropylene glycol polyethylene glycol (meth)acrylate as the hydrophobic group-containing constitutional unit.
<6> The halogen-based resin composition according to any one of the aforementioned aspects <1> to <5>, wherein the polymer dispersant contains the constitutional unit derived from methacrylic acid as the carboxy group-containing constitutional unit in an amount of not less than 5% by mass and not more than 20% by mass on the basis of the whole constitutional units in the polymer dispersant, and the constitutional unit derived from stearyl (meth)acrylate as the hydrophobic group-containing constitutional unit in an amount of not less than 10% by mass and not more than 70% by mass on the basis of the whole constitutional units in the polymer dispersant.
<7> The halogen-based resin composition according to any one of the aforementioned aspects <1> to <5>, wherein the polymer dispersant contains the constitutional unit derived from methacrylic acid as the carboxy group-containing constitutional unit in an amount of not less than 40% by mass and not more than 60% by mass on the basis of the whole constitutional units in the polymer dispersant, and the constitutional unit derived from lauryl methacrylate as the hydrophobic group-containing constitutional unit in an amount of not less than 15% by mass and not more than 60% by mass on the basis of the whole constitutional units in the polymer dispersant.
<8> The halogen-based resin composition according to any one of the aforementioned aspects <1> to <5>, wherein the polymer dispersant contains the constitutional unit derived from methacrylic acid as the carboxy group-containing constitutional unit in an amount of not less than 5% by mass and not more than 20% by mass on the basis of the whole constitutional units in the polymer dispersant, and the constitutional unit derived from 2-ethylhexyloxypropylene glycol polyethylene glycol methacrylate as the hydrophobic group-containing constitutional unit in an amount of not less than 80% by mass and not more than 95% by mass on the basis of the whole constitutional units in the polymer dispersant.
<9> The halogen-based resin composition according to any one of the aforementioned aspects <1> to <5>, wherein the polymer dispersant contains the constitutional unit derived from methacrylic acid as the carboxy group-containing constitutional unit in an amount of not less than 5% by mass and not more than 20% by mass on the basis of the whole constitutional units in the polymer dispersant, and the constitutional unit derived from lauroxypolyethylene glycol monomethacrylate as the hydrophobic group-containing constitutional unit in an amount of not less than 80% by mass and not more than 95% by mass on the basis of the whole constitutional units in the polymer dispersant.
<10> The halogen-based resin composition according to any one of the aforementioned aspects <1> to <5>, wherein the polymer dispersant contains the constitutional unit derived from methacrylic acid as the carboxy group-containing constitutional unit in an amount of not less than 10% by mass and not more than 20% by mass on the basis of the whole constitutional units in the polymer dispersant, and the constitutional unit derived from 2-ethylhexyl methacrylate as the hydrophobic group-containing constitutional unit in an amount of not less than 80% by mass and not more than 90% by mass on the basis of the whole constitutional units in the polymer dispersant.
<11> The halogen-based resin composition according to any one of the aforementioned aspects <1> to <10>, wherein the polymer dispersant is in an unneutralized state.
<12> The halogen-based resin composition according to any one of the aforementioned aspects <1> to <11>, wherein the weight-average molecular weight of the polymer dispersant is not less than 5,000 and not more than 30,000.
<13> The halogen-based resin composition according to any one of the aforementioned aspects <1> to <12>, wherein an acid value of the polymer dispersant is not less than 45 mgKOH/g and not more than 120 mgKOH/g.
<14> The halogen-based resin composition according to any one of the aforementioned aspects <1> to <13>, wherein the halogen-based resin is a vinyl chloride resin.
<15> The halogen-based resin composition according to any one of the aforementioned aspects <1> to <14>, wherein the basic inorganic filler contains calcium carbonate.
<16> The halogen-based resin composition according to the aforementioned aspect <15>, wherein a mass ratio of the polymer dispersant to calcium carbonate (polymer dispersant/calcium carbonate) is not less than 0.0001 and not more than 10.
<17> The halogen-based resin composition according to the aforementioned aspect <15> or <16>, wherein the mass ratio of the polymer dispersant to calcium carbonate (polymer dispersant/calcium carbonate) is not less than 0.0001 and not more than 0.01.
<18> The halogen-based resin composition according to any one of the aforementioned aspects <15> to <17>, wherein the mass ratio of the polymer dispersant to calcium carbonate (polymer dispersant/calcium carbonate) is not less than 0.002 and not more than 0.01.
<19> The halogen-based resin composition according to any one of the aforementioned aspects <1> to <18>, wherein the plasticizer is a phthalic acid ester of an alcohol having from 8 to 13 carbon atoms.
<20> The halogen-based resin composition according to any one of the aforementioned aspects <1> to <19>, wherein a content of the plasticizer in the halogen-based resin composition is not less than 30 parts by mass and not more than 150 parts by mass on the basis of 100 parts by mass of the halogen-based resin.
<21> The halogen-based resin composition according to any one of the aforementioned aspects <1> to <20>, wherein a content of the basic inorganic filler in the halogen-based resin composition is not less than 5 parts by mass and not more than 130 parts by mass on the basis of 100 parts by mass of the halogen-based resin.
<22> The halogen-based resin composition according to the aforementioned aspect <21>, wherein the basic inorganic filler contains calcium carbonate, and a content of calcium carbonate in the halogen-based resin composition is not less than 5 parts by mass and not more than 130 parts by mass on the basis of 100 parts by mass of the halogen-based resin.
<23> The halogen-based resin composition according to any one of the aforementioned aspects <1> to <22>, wherein a content of the polymer dispersant in the halogen-based resin composition is not less than 0.001% by mass and not more than 0.8% by mass.

### EXAMPLES

In the following Production Examples, Examples and Comparative Examples, the “part(s)” and “%” indicate “part(s) by mass” and “% by mass”, respectively, unless otherwise specified.

### [Measurement]

### [Method of Measuring Weight-Average Molecular Weight]

The weight-average molecular weight of the polymer dispersant was measured by gel permeation chromatography (hereinafter also referred to as “GPC”).

That is, the synthesized polymer dispersant was diluted with N,N-dimethylformamide to prepare a solution of the sample having a solid content of 0.3% by mass, and 100 μL of the thus prepared sample solution was subjected to the measurement. Using a solution prepared by dissolving phosphoric acid and lithium bromide in N,N-dimethylformamide such that concentrations of phosphoric acid and lithium bromide in the resulting solution were 60 mmol/L and 50 mmol/L, respectively, as an eluent, the measurement was conducted by GPC [apparatus: “HLC-8320GPC” available from Tosoh Corporation; detector: differential refractometer (attached to the apparatus); columns: “TSK-GEL, α-M”×2 available from Tosoh Corporation; column temperature: 40° C.; flow rate of the eluent: 1 mL/min].

As reference standard substances for the measurement, there were used polystyrenes having molecular weights of 5.26×10², 1.02×10⁵ and 8.42×10⁶ available from Tosoh Corporation, and polystyrenes having molecular weights of 4.0×10³, 3.0×10⁴ and 9.0×10⁵ available from Nishio Industry Co., Ltd.

### [Method of Measuring Slurry Viscosity]

The viscosity of the halogen-based resin composition or the mixture of the polymer dispersant, the plasticizer and the basic inorganic filler was measured using a rheometer “MCR-302” (tradename) available from Anton Paar GmbH. In the measurement, using a 25 mmφ parallel plate as a jig, the sample was subjected to a shear rate sweep test at 25° C. in a shear rate range of from 0.1 s⁻¹ to 10 s⁻¹. The value of the viscosity of the sample as measured at a shear rate of 1 s⁻¹ was defined and used as a slurry viscosity of the halogen-based resin composition or the mixture.

### [Measurement of Bleed-Out Rate]

A molded sheet of the halogen-based resin composition was cut into a test piece (1.7 g) having a size of 4 cm×4 cm. One surface of the test piece was washed with 2 g of deuterated methanol containing 0.1% by weight of TMS, and the resulting deuterated methanol solution was subjected to 1H-NMR measurement to analyze the solution. The mass of the polymer dispersant or surfactant in the deuterated methanol solution was determined from the integrated value of a peak derived from the polymer dispersant or surfactant compounded in the halogen-based resin composition. Whereas, the amount of the polymer dispersant or surfactant compounded in 1.7 g of the test piece was calculated from the amount of the polymer dispersant or surfactant charged in the halogen-based resin composition. The bleed-out rate of the polymer dispersant or surfactant was determined as a ratio (%) of the mass of the polymer dispersant or surfactant in the deuterated methanol solution relative to the amount of the polymer dispersant or surfactant compounded in the test piece. In this measuring method, the bleed-out rate of 0.2% by weight was still detectable, and “ND” (Not Detected) shown in the Tables indicates that the bleed-out rate was less than 0.2% by weight.

### [Measurement of Solid Content]

Sodium sulfate dried to a constant weight in a desiccator was weighed and charged in an amount of 10.0 parts in a 30 mL glass petri dish, and about 1.0 g of a sample to be measured was added to the glass petri dish. The contents of the glass petri dish were mixed together and then accurately weighed. The resulting mixture was maintained in the glass petri dish at 105° C. for 2 hours to remove volatile components therefrom, and further allowed to stand in a desiccator for 15 minutes, followed by measuring a mass of the sample. The mass of the sample after removing the volatile components therefrom was regarded as a mass of solids in the sample. The solid content of the sample was calculated by dividing the mass of the solids by the mass of the sample initially added.

### [Production of Polymer Dispersant]

### Production Example 1 (Production of Polymer Dispersant 1)

A 1-L four-necked separable flask was charged with 7.9 g of stearyl methacrylate “NK ESTER S” (tradename) available from Shin-Nakamura Chemical Co., Ltd., 7.9 g of methacrylic acid available from FUJIFILM Wako Pure Chemical Corporation, 36.7 g of methoxypolyethylene glycol methacrylate “NK ESTER TM-230G” (tradename; 23 mol of EO added on average) available from Shin-Nakamura Chemical Co., Ltd., and 26.0 g of ethanol, and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 1.6 g of a polymerization initiator “V-65B” (tradename) available from FUJIFILM Wako Pure Chemical Corporation and 8.9 g of ethanol was added thereto. The resulting initial mixture was stirred for 10 minutes.

Next, while maintaining the temperature of the reaction system, a mixed solution of 31.5 g of stearyl methacrylate, 31.5 g of methacrylic acid, 148.8 g of the aforementioned methoxypolyethylene glycol methacrylate and 104.2 g of ethanol, and a mixed solution of 6.3 g of the aforementioned polymerization initiator and 35.6 g of ethanol were separately added dropwise into the flask over 180 minutes (in Table 1, these mixed solutions are referred to as “dropping mixtures”). After completion of the dropwise addition, the resulting solution was stirred at 80° C. for 180 minutes, followed by cooling the solution to room temperature. The solid content of the thus obtained polymer solution was 60.1%. The resulting polymer solution was weighed in an amount of 10.0 g in a glass petri dish, and dried under reduced pressure at 80° C. for 3 hours, thereby obtaining a polymer dispersant 1.

The weight-average molecular weight of the thus obtained polymer dispersant 1 was 27,000.

### Production Example 2 (Production of Polymer Dispersant 2)

Carboxy groups contained in the polymer dispersant 1 were neutralized by adding 0.6 g of a 4N sodium hydroxide solution to 10.0 g of the polymer solution produced in Production Example 1 (solid components: 6.0 g; content of the constitutional unit derived from methacrylic acid in the polymer: 14.9% by mass) and then stirring the obtained mixture for 30 minutes. The resulting polymer solution was dried under reduced pressure at 80° C. for 3 hours, thereby obtaining a polymer dispersant 2 (a 20% neutralized product of the polymer dispersant 1).

### Production Example 3 (Production of Polymer Dispersant 3)

A 1-L four-necked separable flask was charged with 20.3 g of stearyl acrylate, 6.8 g of methacrylic acid, 18.0 g of methoxypolyethylene glycol methacrylate “NK ESTER TM-230G” (tradename; 23 mol of EO added on average) available from Shin-Nakamura Chemical Co., Ltd., 1.8 g of mercaptopropanediol (polymerization chain transfer agent) available from FUJIFILM Wako Pure Chemical Corporation and 27.0 g of ethanol, and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 1.4 g of the aforementioned polymerization initiator and 11.3 g of ethanol was added thereto. The resulting initial mixture was stirred for 10 minutes.

Next, while maintaining the temperature of the reaction system, a mixed solution of 182.3 g of stearyl acrylate, 60.8 g of methacrylic acid, 162.0 g of the aforementioned methoxypolyethylene glycol methacrylate, 16.2 g of mercaptopropanediol and 143.0 g of ethanol, and a mixed solution of 12.2 g of the aforementioned polymerization initiator and 100.0 g of ethanol were separately added dropwise into the flask over 180 minutes. After completion of the dropwise addition, the resulting solution was stirred at 80° C. for 180 minutes, followed by cooling the solution to room temperature. Then, 556.3 g of toluene and 275.3 g of ethanol were added to the solution to adjust a solid content thereof to 30.4%. The resulting polymer solution was weighed in an amount of 10.0 g in a glass petri dish, and dried under reduced pressure at 80° C. for 3 hours, thereby obtaining a polymer dispersant 3.

The weight-average molecular weight of the thus obtained polymer dispersant 3 was 5,800.

### Production Example 4 (Production of Polymer Dispersant 4)

A 1-L four-necked separable flask was charged with 4.5 g of stearyl methacrylate, 1.5 g of methacrylic acid, 4.0 g of methoxypolyethylene glycol methacrylate “NK ESTER TM-230G” (tradename; 23 mol of EO added on average) available from Shin-Nakamura Chemical Co., Ltd., and 24.7 g of a toluene/ethanol mixed solution (mass ratio: 50/50), and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 0.02 g of the aforementioned polymerization initiator and 5.7 g of the toluene/ethanol mixed solution (mass ratio: 50/50) was added thereto, followed by continuously stirring the resulting mixture for 10 minutes.

Next, while maintaining the temperature of the reaction system, a mixed solution of 40.5 g of stearyl methacrylate, 13.5 g of methacrylic acid, 36.0 g of the aforementioned methoxypolyethylene glycol methacrylate and 42.1 g of the toluene/ethanol mixed solution (mass ratio: 50/50), and a mixed solution of 0.15 g of the aforementioned polymerization initiator and 50.9 g of the toluene/ethanol mixed solution (mass ratio: 50/50) were separately added dropwise into the flask over 120 minutes. After completion of the dropwise addition, the resulting solution was stirred at 80° C. for 120 minutes, followed by cooling the solution. The solid content of the thus obtained polymer solution was 45.2% by mass. The resulting polymer solution was weighed in an amount of 10.0 g in a glass petri dish, and dried under reduced pressure at 100° C. for 5 hours, thereby obtaining a polymer dispersant 4.

The weight-average molecular weight of the thus obtained polymer dispersant 4 was 166,000.

### Production Example 5 (Production of Polymer Dispersant 5)

Carboxy groups contained in the polymer dispersant 1 were neutralized by adding 1.5 g of a 4N sodium hydroxide solution to 10.0 g of the polymer solution produced in Production Example 1 (solid components: 6.0 g; content of the constitutional unit derived from methacrylic acid in the polymer: 14.9% by mass) and then stirring the obtained mixture for 30 minutes. The resulting polymer solution was dried under reduced pressure at 80° C. for 3 hours, thereby obtaining a polymer dispersant 5 (a 50% neutralized product of the polymer dispersant 1).

### Production Example 6 (Production of Polymer Dispersant 6)

A 1-L four-necked separable flask was charged with 0.75 g of stearyl methacrylate, 0.75 g of methacrylic acid, 3.5 g of methoxypolyethylene glycol methacrylate “NK ESTER TM-230G” (tradename; 23 mol of EO added on average) available from Shin-Nakamura Chemical Co., Ltd., and 11.7 g of ethanol, and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 0.007 g of the aforementioned polymerization initiator and 2.3 g of ethanol was added thereto. The resulting initial mixture was stirred for 10 minutes.

Next, while maintaining the temperature of the reaction system, a mixed solution of 6.8 g of stearyl methacrylate, 6.8 g of methacrylic acid, 31.5 g of the aforementioned methoxypolyethylene glycol methacrylate and 15.1 g of ethanol, and a mixed solution of 0.063 g of the aforementioned polymerization initiator and 20.9 g of ethanol were separately added dropwise into the flask over 180 minutes. After completion of the dropwise addition, the resulting solution was stirred at 80° C. for 180 minutes, followed by cooling the solution to room temperature. The resulting polymer solution was weighed in an amount of 10.0 g in a glass petri dish, and dried under reduced pressure at 80° C. for 3 hours, thereby obtaining a polymer dispersant 6. The content of a constitutional unit derived from an α,β-unsaturated carboxylic acid in the polymer dispersant 6 was 15.0%.

The weight-average molecular weight of the thus obtained polymer dispersant 6 was 418,000.

### Production Example 7 (Production of Polymer Dispersant 7)

A 1-L four-necked separable flask was previously charged with 100.0 g of a toluene/ethanol mixed solution (mass ratio: 50/50), and two dropping funnels, a reflux condenser, a thermometer and a stirring device were fitted to the flask. After replacing an atmosphere of the reaction system with nitrogen, the mixed solution in the flask was heated to 80° C. while stirring. While maintaining the temperature of the reaction system, a mixed solution of 300.0 g of stearyl methacrylate, 75.0 g of methacrylic acid, 125.0 g of methoxypolyethylene glycol methacrylate “NK ESTER M-450G” (tradename; 45 mol of EO added on average) available from Shin-Nakamura Chemical Co., Ltd., 4.9 g of mercaptopropanediol and 350.4 g of the toluene/ethanol mixed solution (mass ratio: 50/50), and a mixed solution of 6.8 g of the aforementioned polymerization initiator and 49.6 g of the toluene/ethanol mixed solution (mass ratio: 50/50) were separately added dropwise into the flask over 120 minutes. After completion of the dropwise addition, the resulting solution was stirred at 80° C. for 60 minutes, followed by cooling the solution to room temperature. The solid content of the thus obtained polymer solution was 49.7%. The resulting polymer solution was weighed in an amount of 10.0 g in a glass petri dish, and dried under reduced pressure at 100° C. for 5 hours, thereby obtaining a polymer dispersant 7. The content of a constitutional unit derived from an α,β-unsaturated carboxylic acid in the polymer dispersant 7 was 15.0%, and the content of a hydrophobic group-containing constitutional unit in the polymer dispersant 7 was 60.0%.

The weight-average molecular weight of the thus obtained polymer dispersant 7 was 14,300.

### Production Example 8 (Production of Polymer Dispersant 8)

The same procedure as in Production Example 3 was repeated except that the amounts of the respective components compounded were changed to those shown in Table 1, thereby obtaining a polymer dispersant 8.

The weight-average molecular weight of the thus obtained polymer dispersant 8 was 8,600.

### Production Example 9 (Production of Polymer Dispersant 9)

A 1-L four-necked separable flask was charged with 450.0 g of toluene, 224.0 g of diisobutylene available from FUJIFILM Wako Pure Chemical Corporation, 198.0 g of maleic anhydride available from FUJIFILM Wako Pure Chemical Corporation and 13.3 g of benzoyl peroxide (polymerization initiator) available from Tokyo Chemical Industry Co., Ltd., and a reflux condenser, a thermometer and a stirring device were fitted to the flask. After replacing an atmosphere of the reaction system with nitrogen, the contents of the flask were heated to 83° C. while stirring. While maintaining the temperature of the reaction system, the contents of the flask were reacted for 240 minutes. Then, the obtained reaction mixture was transferred to a vat coated with Teflon (trademark), and dried under reduced pressure at 100° C. for 5 hours. The weight-average molecular weight of the resulting polymer was 28,600.

In addition, a 1-L four-necked separable flask was charged with 136.0 g of methyl isobutyl ketone and 24.8 g of the above-obtained solids (containing 0.12 mol of a constituent derived from maleic anhydride). After replacing an atmosphere of the reaction system with nitrogen, the solids were dissolved in the solvent while stirring at room temperature over 2 hours. Then, the resulting solution in the flask was heated up to 72° C. while stirring, and 32.0 g (0.12 mol) of stearyl amine “FARMIN 80” (tradename) available from Kao Corporation which had been previously molten at 80° C. was added to the solution. The obtained mixed solution was stirred at 72° C. for 120 minutes to subject the solution to amidation reaction, followed by cooling the obtained reaction solution to room temperature. The solid content of the thus obtained polymer solution was 30.1%. The resulting polymer solution was weighed in an amount of 10.0 g in a glass petri dish, and dried under reduced pressure at 100° C. for 5 hours, thereby obtaining a polymer dispersant 9.

Since the thus obtained polymer dispersant 9 was insoluble in an eluent for GPC, the weight-average molecular weight of the polymer dispersant 9 was calculated from the aforementioned GPC measured value. As a result of the calculation, the weight-average molecular weight of the polymer dispersant 9 was 67,400.

### Production Example 10 (Production of Polymer Dispersant 10)

A 1-L four-necked separable flask was charged with 8.5 g of 2-ethylhexyl methacrylate, 1.5 g of methacrylic acid, 0.13 g of mercaptopropanediol and 22.1 g of a toluene/ethanol mixed solution (mass ratio: 50/50), and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 0.12 g of the aforementioned polymerization initiator and 5.9 g of the toluene/ethanol mixed solution (mass ratio: 50/50) was added thereto. The resulting initial mixture was stirred for 10 minutes.

Next, while maintaining the temperature of the reaction system, a mixed solution of 76.5 g of 2-ethylhexyl methacrylate, 13.5 g of methacrylic acid, 1.2 g of mercaptopropanediol and 19.2 g of the toluene/ethanol mixed solution (mass ratio: 50/50), and a mixed solution of 0.11 g of the aforementioned polymerization initiator and 52.8 g of the toluene/ethanol mixed solution (mass ratio: 50/50) were separately added dropwise into the flask over 120 minutes. After completion of the dropwise addition, the resulting solution was stirred at 80° C. for 120 minutes, followed by cooling the solution to room temperature. The resulting polymer solution was weighed in an amount of 10.0 g in a glass petri dish, and dried under reduced pressure at 100° C. for 5 hours, thereby obtaining a polymer dispersant 10.

The weight-average molecular weight of the thus obtained polymer dispersant 10 was 10,400.

### Production Example 11 (Production of Polymer Dispersant 11)

The same procedure as in Production Example 10 was repeated except that 2-ethylhexyl methacrylate was replaced with 2-ethylhexyloxy polyethylene glycol polypropylene glycol methacrylate “BLEMMER 50POEP-800B” (tradename; 8 mol of EO added on average; 7 mol of PO added on average) available from NOF Corporation, the solvent was replaced with ethanol, and the amounts of the respective components compounded were changed to those shown in Table 1, thereby obtaining a polymer dispersant 11.

The weight-average molecular weight of the thus obtained polymer dispersant 11 was 7,700.

### Production Example 12 (Production of Polymer Dispersant 12)

The same procedure as in Production Example 10 was repeated except that 2-ethylhexyl methacrylate was replaced with 2-ethylhexyloxy polyethylene glycol polypropylene glycol methacrylate “BLEMMER 50POEP-800B” (tradename; 8 mol of EO added on average; 7 mol of PO added on average) available from NOF Corporation, and the amounts of the respective components compounded were changed to those shown in Table 1, thereby obtaining a polymer dispersant 12.

The weight-average molecular weight of the thus obtained polymer dispersant 12 was 8,700.

### Production Example 13 (Production of Polymer Dispersant 13)

The same procedure as in Production Example 10 was repeated except that 2-ethylhexyl methacrylate was replaced with lauroxy polyethylene glycol methacrylate “BLEMMER PLE200” (tradename; 4 mol of EO added on average) available from NOF Corporation, and the amounts of the respective components compounded were changed to those shown in Table 1, thereby obtaining a polymer dispersant 13.

The weight-average molecular weight of the thus obtained polymer dispersant 13 was 16,400.

### Production Example 14 (Production of Polymer Dispersant 14)

The same procedure as in Production Example 10 was repeated except that 2-ethylhexyl methacrylate was replaced with 2-ethylhexyloxy polyethylene glycol polypropylene glycol methacrylate “BLEMMER 50POEP-800B” (tradename; 8 mol of EO added on average; 7 mol of PO added on average) available from NOF Corporation, the solvent was replaced with ethanol, and the amounts of the respective components compounded were changed to those shown in Table 1, thereby obtaining a polymer dispersant 14.

The weight-average molecular weight of the thus obtained polymer dispersant 14 was 27,100.

### Production Example 15 (Production of Polymer Dispersant 15)

The same procedure as in Production Example 3 was repeated except that stearyl acrylate was replaced with lauryl methacrylate, the solvent was replaced with a toluene/ethanol mixed solution (mass ratio: 50/50), and the amounts of the respective components compounded were changed to those shown in Table 1, thereby obtaining a polymer dispersant 15.

The weight-average molecular weight of the thus obtained polymer dispersant 15 was 17,400.

### Production Example 16 (Production of Polymer Dispersant 16)

The same procedure as in Production Example 3 was repeated except that stearyl acrylate was replaced with lauryl methacrylate, and the amounts of the respective components compounded were changed to those shown in Table 1, thereby obtaining a polymer dispersant 16.

The weight-average molecular weight of the thus obtained polymer dispersant 16 was 15,200.

### Production Example 17 (Production of Polymer Dispersant 17)

The same procedure as in Production Example 10 was repeated except that 2-ethylhexyl methacrylate was replaced with stearoxypolyethylene glycol methacrylate “BLEMMER PSE1300” (tradename; 30 mol of EO added on average) available from NOF Corporation, the solvent was replaced with ethanol, and the amounts of the respective components compounded were changed to those shown in Table 1, thereby obtaining a polymer dispersant 17.

The weight-average molecular weight of the thus obtained polymer dispersant 17 was 13,900.

TABLE 1

| | | Production Examples | | | | | | | | | | | | | |
|---|---|---|---|---|---|---|---|---|---|---|---|---|---|---|---|
| | | 1 | 3 | 4 | 6 | 7 | 8 | 10 | 11 | 12 | 13 | 14 | 15 | 16 | 17 |
| | | Kind of polymer dispersant | | | | | | | | | | | | | |
| | | 1 | 3 | 4 | 6 | 7 | 8 | 10 | 11 | 12 | 13 | 14 | 15 | 16 | 17 |
| Initial | Methacrylic acid | 7.9 | 6.8 | 1.5 | 0.75 | | 3.4 | 1.5 | 3.0 | 1.5 | 1.5 | 0.5 | 0.8 | 1.5 | 1.5 |
| mixture | Stearyl acrylate | | 20.3 | | | | | | | | | | | | |
| | Stearyl methacrylate | 7.9 | | 4.5 | 0.75 | | 20.3 | | | | | | | | |
| | Lauryl methacrylate | | | | | | | | | | | | 5.3 | 4.5 | |
| | Methoxy PEG23 | 36.7 | 18.0 | 4.0 | 3.5 | | 21.4 | | | | | | 4.0 | 4.0 | |
| | methacrylate*¹ | | | | | | | | | | | | | | |
| | 2EHMA*³ | | | | | | | 8.5 | | | | | | | |
| | PLE200*⁴ | | | | | | | | | | 8.5 | | | | |
| | 50POEP-800B*⁵ | | | | | | | | 17.0 | 18.5 | | 9.5 | | | |
| | PSE1300*⁶ | | | | | | | | | | | | | | 18.5 |
| | Mercaptopropanediol | | 1.8 | | | | 0.9 | 0.13 | 0.7 | 0.5 | 0.08 | 0.09 | 0.07 | 0.10 | 0.39 |
| | Toluene/ethanol (1/1) | | | 24.7 | | 100.0 | | 22.1 | | | 20.7 | | 15.8 | | |
| | Ethanol | 26.0 | 27.0 | | 11.7 | | 27.0 | | 74.0 | 74.0 | | 13.9 | | 15.3 | 76.8 |
| | Polymerization initiator | 1.6 | 1.4 | 0.02 | 0.007 | | 0.5 | 0.12 | 0.6 | 0.4 | 0.07 | 0.08 | 0.06 | 0.07 | 0.29 |
| | Toluene/ethanol (1/1) | | | 5.7 | | | | 5.9 | | | 7.3 | | 2.8 | | |
| | Ethanol | 8.9 | 11.3 | | 2.3 | | 11.3 | | 10.0 | 10.0 | | 4.7 | | 3.3 | 7.2 |
| Dropping | Methacrylic acid | 31.5 | 60.8 | 13.5 | 6.8 | 75.0 | 30.4 | 13.5 | 27.0 | 13.5 | 13.5 | 4.5 | 6.8 | 13.5 | 13.5 |
| mixtures | Stearyl acrylate | | 182.3 | | | | | | | | | | | | |
| | Stearyl methacrylate | 31.5 | | 40.5 | 6.8 | 300.0 | 182.3 | | | | | | | | |
| | Lauryl methacrylate | | | | | | | | | | | | 47.3 | 40.5 | |
| | Methoxy PEG23 | 148.8 | 162.0 | 36.0 | 31.5 | | 192.4 | | | | | | 36.0 | 36.0 | |
| | methacrylate*¹ | | | | | | | | | | | | | | |
| | Methoxy PEG45 | | | | | 125.0 | | | | | | | | | |
| | methacrylate*² | | | | | | | | | | | | | | |
| | 2EHMA*³ | | | | | | | 76.5 | | | | | | | |
| | PLE200*⁴ | | | | | | | | | | 76.5 | | | | |
| | 50POEP-800B*⁵ | | | | | | | | 153.0 | 166.5 | | 85.5 | | | |
| | PSE1300*⁶ | | | | | | | | | | | | | | 166.5 |
| | Mercaptopropanediol | | 16.2 | | | 4.9 | 8.1 | 1.2 | 6.5 | 4.9 | 0.72 | 0.80 | 0.64 | 0.90 | 3.51 |
| | Toluene/ethanol (1/1) | | | 42.1 | | 350.4 | | 19.2 | | | 6.2 | | 22.8 | | |
| | Ethanol | 104.2 | 143.0 | | 15.1 | | 143.0 | | 126.0 | 126.2 | | 5.7 | | 18.4 | 151.5 |
| | Polymerization initiator | 6.3 | 12.2 | 0.15 | 0.063 | 6.8 | 4.1 | 0.11 | 5.0 | 3.7 | 0.67 | 0.73 | 0.51 | 0.60 | 2.69 |
| | Toluene/ethanol (1/1) | | | 50.9 | | 49.6 | | 52.8 | | | 65.8 | | 25.3 | | |
| | Ethanol | 35.6 | 100.0 | | 20.9 | | 100.0 | | 90.0 | 89.8 | | 42.3 | | 29.7 | 6.5 |

| | | | | | | | | | | | | | | |
|---|---|---|---|---|---|---|---|---|---|---|---|---|---|---|
| Content of hydrophobic | 15.0 | 45.0 | 45.0 | 15.0 | 60.0 | 45.0 | 85.0 | 85.0 | 92.5 | 85.0 | 95.0 | 52.5 | 45.0 | 92.5 |
| monomers (% by mass)*⁷ | | | | | | | | | | | | | | |

In Table 1, the numerical values of the respective components are on the basis of a part(s) by mass thereof.
*¹Methoxypolyethylene glycol methacrylate “NK ESTER TM-230G” (tradename; 23 mol of EO added on average) available from Shin-Nakamura Chemical Co., Ltd.
*²Methoxypolyethylene glycol methacrylate “NK ESTER TM-450G” (tradename; 45 mol of EO added on average) available from Shin-Nakamura Chemical Co., Ltd.
*³2-Ethylhexyl methacrylate
*⁴Lauroxy polyethylene glycol methacrylate “BLEMMER PLE200” (tradename) available from NOF Corporation
*⁵2-Ethylhexyloxy polypropylene glycol polyethylene glycol methacrylate “BLEMMER 50POEP-800B” (tradename) available from NOF Corporation
*⁶Stearoxy polyethylene glycol methacrylate “BLEMMER PSE1300” (tradename) available from NOF Corporation
*⁷Content of hydrophobic group-containing constitutional units in the polymer dispersant

The contents of the constitutional units in the polymer dispersants 1 to 17 produced in Production Examples 1 to 17, respectively, as well as the weight-average molecular weights, acid values and neutralization degrees of the polymer dispersants 1 to 17 are collectively shown in Table 2.

TABLE 2

| | | Production Examples | | | | | | | |
|---|---|---|---|---|---|---|---|---|---|
| | | 1 | 2 | 3 | 4 | 5 | 6 | 7 | 8 |
| | | Kind of polymer dispersant | | | | | | | |
| | | 1 | 2 | 3 | 4 | 5 | 6 | 7 | 8 |
| Constitutional | Methacrylic acid | 14.9 | 14.9 | 15.0 | 15.0 | 14.9 | 15.0 | 15.0 | 7.5 |
| units | Stearyl acrylate | 0.0 | 0.0 | 45.0 | 0.0 | 0.0 | 0.0 | 0.0 | 0.0 |
| | Stearyl methacrylate | 14.9 | 14.9 | 0.0 | 45.0 | 14.9 | 15.1 | 60.0 | 45.0 |
| | Lauryl methacrylate | 0.0 | 0.0 | 0.0 | 0.0 | 0.0 | 0.0 | 0.0 | 0.0 |
| | Methoxy PEG23 | 70.2 | 70.2 | 40.0 | 40.0 | 70.2 | 69.9 | 0.0 | 47.5 |
| | methacrylate*¹ | | | | | | | | |
| | Methoxy PEG45 | 0.0 | 0.0 | 0.0 | 0.0 | 0.0 | 0.0 | 25.0 | 0.0 |
| | methacrylate*² | | | | | | | | |
| | 2EHMA*³ | 0.0 | 0.0 | 0.0 | 0.0 | 0.0 | 0.0 | 0.0 | 0.0 |
| | PLE200*⁴ | 0.0 | 0.0 | 0.0 | 0.0 | 0.0 | 0.0 | 0.0 | 0.0 |
| | 50POEP-800B*⁵ | 0.0 | 0.0 | 0.0 | 0.0 | 0.0 | 0.0 | 0.0 | 0.0 |
| | PSE1300*⁶ | 0.0 | 0.0 | 0.0 | 0.0 | 0.0 | 0.0 | 0.0 | 0.0 |
| | Monostearyl maleate | 0.0 | 0.0 | 0.0 | 0.0 | 0.0 | 0.0 | 0.0 | 0.0 |
| | Diisobutylene | 0.0 | 0.0 | 0.0 | 0.0 | 0.0 | 0.0 | 0.0 | 0.0 |

| | | | | | | | | |
|---|---|---|---|---|---|---|---|---|
| Weight-average molecular weight | 27,000 | 27,000 | 5,800 | 166,000 | 27,000 | 418,000 | 14,300 | 8,600 |
| Acid value (mgKOH/g) | 94.4 | 94.4 | 92.1 | 101.8 | 94.4 | 94.4 | 97.6 | 48.3 |
| Neutralization degree (mol %) | Unneu- | 20 | Unneu- | Unneu- | 50 | Unneu- | Unneu- | Unneu- |
| | tralized | | tralized | tralized | | tralized | tralized | tralized |

| | | Production Examples | | | | | | | | |
|---|---|---|---|---|---|---|---|---|---|---|
| | | 9 | 10 | 11 | 12 | 13 | 14 | 15 | 16 | 17 |
| | | Kind of polymer dispersant | | | | | | | | |
| | | 9 | 10 | 11 | 12 | 13 | 14 | 15 | 16 | 17 |
| Constitutional | Methacrylic acid | 0.0 | 15.0 | 15.0 | 7.5 | 15.0 | 5.0 | 7.5 | 15.0 | 7.5 |
| units | Stearyl acrylate | 0.0 | 0.0 | 0.0 | 0.0 | 0.0 | 0.0 | 0.0 | 0.0 | 0.0 |
| | Stearyl methacrylate | 0.0 | 0.0 | 0.0 | 0.0 | 0.0 | 0.0 | 0.0 | 0.0 | 0.0 |
| | Lauryl methacrylate | 0.0 | 0.0 | 0.0 | 0.0 | 0.0 | 0.0 | 52.5 | 45.0 | 0.0 |
| | Methoxy PEG23 | 0.0 | 0.0 | 0.0 | 0.0 | 0.0 | 0.0 | 40.0 | 40.0 | 0.0 |
| | methacrylate*¹ | | | | | | | | | |
| | Methoxy PEG45 | 0.0 | 0.0 | 0.0 | 0.0 | 0.0 | 0.0 | 0.0 | 0.0 | 0.0 |
| | methacrylate*² | | | | | | | | | |
| | 2EHMA*³ | 0.0 | 85.0 | 0.0 | 0.0 | 0.0 | 0.0 | 0.0 | 0.0 | 0.0 |
| | PLE200*⁴ | 0.0 | 0.0 | 0.0 | 0.0 | 85.0 | 0.0 | 0.0 | 0.0 | 0.0 |
| | 50POEP-800B*⁵ | 0.0 | 0.0 | 85.0 | 92.5 | 0.0 | 95.0 | 0.0 | 0.0 | 0.0 |
| | PSE1300*⁶ | 0.0 | 0.0 | 0.0 | 0.0 | 0.0 | 0.0 | 0.0 | 0.0 | 92.5 |
| | Monostearyl maleate | 75.0 | 0.0 | 0.0 | 0.0 | 0.0 | 0.0 | 0.0 | 0.0 | 0.0 |
| | Diisobutylene | 25.0 | 0.0 | 0.0 | 0.0 | 0.0 | 0.0 | 0.0 | 0.0 | 0.0 |

| | | | | | | | | | |
|---|---|---|---|---|---|---|---|---|---|
| Weight-average molecular weight | 67,400 | 10,400 | 7,700 | 8,700 | 16,400 | 27,100 | 17,400 | 15,200 | 13,900 |
| Acid value (mgKOH/g) | 114.4 | 99.0 | 93.8 | 47.0 | 98.0 | 31.3 | 30.2 | 59.0 | 47.9 |
| Neutralization degree (mol %) | Unneu- | Unneu- | Unneu- | Unneu- | Unneu- | Unneu- | Unneu- | Unneu- | Unneu- |
| | tralized | tralized | tralized | tralized | tralized | tralized | tralized | tralized | tralized |

*¹Methoxypolyethylene glycol methacrylate “NK ESTER TM-230G” (tradename; 23 mol of EO added on average) available from Shin-Nakamura Chemical Co., Ltd.
*²Methoxypolyethylene glycol methacrylate “NK ESTER TM-450G” (tradename; 45 mol of EO added on average) available from Shin-Nakamura Chemical Co., Ltd.
*³2-Ethylhexyl methacrylate
*⁴Lauroxy polyethylene glycol methacrylate “BLEMMER PLE200” (tradename) available from NOF Corporation
*⁵2-Ethylhexyloxy polypropylene glycol polyethylene glycol methacrylate “BLEMMER 50POEP-800B” (tradename) available from NOF Corporation
*⁶Stearoxy polyethylene glycol methacrylate “BLEMMER PSE1300” (tradename) available from NOF Corporation

### [Production of Halogen-Based Resin Composition for Measurement of Slurry Viscosity]

### Example 1-1

The polymer dispersant 3 in an amount of 0.2 g (corresponding to 0.5% in terms of a concentration of the polymer dispersant relative to a mass of calcium carbonate), 55.0 g of a plasticizer (bis(2-ethylhexyl) phthalate) available from FUJIFILM Wako Pure Chemical Corporation, 40.0 g of calcium carbonate “WHITE H” (tradename) available from Shiraishi Calcium Kaisha Ltd., and 40.0 g of a vinyl chloride resin “PSL-675” (tradename; average polymerization degree: 800) available from Kaneka Corporation were sequentially charged into a 500 mL plastic cup in this order, and homogeneously mixed together using a spatula. Thereafter, the resulting mixture was mixed using a Labomixer at a rotating speed of 5,000 rpm for 3 minutes. Then, the obtained mixture was allowed to stand at room temperature under reduced pressure for 10 minutes to subject the mixture to defoaming, thereby obtaining a halogen-based resin composition. The slurry viscosity of the thus obtained halogen-based resin composition as measured at 25° C. was 13 Pa·s.

### Comparative Example 1-1

The same procedure as in Example 1-1 was repeated except that no polymer dispersant 3 was used, thereby obtaining a halogen-based resin composition. The slurry viscosity of the thus obtained halogen-based resin composition as measured at 25° C. was 36 Pa·s.

TABLE 3

| | | | | Evaluation |
|---|---|---|---|---|
| | | Polymer dispersant, etc. | | results |
| | | | Concentration | Slurry viscosity |
| | | Kind | (% by mass)*¹ | (Pa · s) |
| Example | 1-1 | 3 | 0.5 | 13 |
| Comparative | 1-1 | — | — | 36 |
| Example | | | | |

*¹Concentration of the polymer dispersant, etc., relative to a mass of calcium carbonate

As shown in Table 3, from the results of Example 1-1 and Comparative Example 1-1, it was confirmed that by using the polymer dispersant, the slurry viscosity of the halogen-based resin composition was reduced, and the halogen-based resin composition was therefore improved in processability.

In addition, in production of the composition as described in the Patent Literature 1, it is necessary that the basic inorganic filler is used in the form of a water dispersion thereof in order to precipitate the filler along with the neutralized surfactant. However, as indicated in Example 1-1, in the production of the halogen-based resin composition of the present invention, it was possible to directly mix the polymer dispersant, the plasticizer, the basic inorganic filler and the halogen-based resin with each other. Therefore, the halogen-based resin composition of the present invention can be produced with high production efficiency.

### [Measurement of Slurry Viscosity of Mixture Obtained by Collectively Adding Respective Components at One Time]

### Example 2-1

The polymer dispersant 1 in an amount of 0.4 g (corresponding to 0.5% in terms of a concentration of the polymer dispersant relative to a mass of calcium carbonate), 40 g of a plasticizer (bis(2-ethylhexyl) phthalate) available from FUJIFILM Wako Pure Chemical Corporation and 85 g of calcium carbonate “WHITE H” (tradename) available from Shiraishi Calcium Kaisha Ltd., were sequentially charged into a 500 mL plastic cup in this order, and homogeneously mixed together using a spatula. Thereafter, the resulting mixture was mixed using a Labomixer at a rotating speed of 5,000 rpm for 3 minutes. Then, the obtained mixture was allowed to stand at room temperature under reduced pressure for 10 minutes to subject the mixture to defoaming, thereby obtaining a mixture of the polymer dispersant 1, the plasticizer and calcium carbonate. The slurry viscosity of the thus obtained mixture as measured at 25° C. was 10 Pa·s.

### Examples 2-2 to 2-14 and Comparative Examples 2-1 and 2-2

The same procedure as in Example 2-1 was repeated except that the kind of polymer dispersant was changed to those shown in Table 4, thereby preparing mixtures, and the slurry viscosities of the thus prepared mixtures were measured at 25° C. The results are shown in Table 4.

### Comparative Example 2-3

The same procedure as in Example 2-1 was repeated except that no polymer dispersant 1 was used, thereby preparing a mixture, and the slurry viscosity of the thus prepared mixture was measured at 25° C. The results are shown in Table 4.

TABLE 4

| | | | | Evaluation |
|---|---|---|---|---|
| | | Polymer dispersant, etc. | | results |
| | | | Concentration | Slurry viscosity |
| | | Kind | (% by mass)*¹ | (Pa · s) |
| Examples | 2-1 | 1 | 0.5 | 10 |
| | 2-2 | 2 | 0.5 | 52 |
| | 2-3 | 3 | 0.5 | 0.9 |
| | 2-4 | 4 | 0.5 | 4.5 |
| | 2-5 | 7 | 0.5 | 48 |
| | 2-6 | 8 | 0.5 | 0.9 |
| | 2-7 | 10 | 0.5 | 10.2 |
| | 2-8 | 11 | 0.5 | 0.9 |
| | 2-9 | 12 | 0.5 | 0.9 |
| | 2-10 | 13 | 0.5 | 1.2 |
| | 2-11 | 14 | 0.5 | 0.9 |
| | 2-12 | 15 | 0.5 | 1.2 |
| | 2-13 | 16 | 0.5 | 10.5 |
| | 2-14 | 17 | 0.5 | 0.9 |
| Comparative | 2-1 | 5 | 0.5 | 119 |
| Examples | 2-2 | 6 | 0.5 | 150 |
| | 2-3 | — | — | 104 |

*¹Concentration of the Polymer dispersant relative to a mass of calcium carbonate

From the results of Example 1-1 and Examples 2-1 to 2-14, it was confirmed that in the case where the slurry viscosities of the mixtures each composed of the polymer dispersant, the plasticizer and the basic inorganic filler were sufficiently low, the resulting halogen-based resin compositions were improved in processability. Incidentally, in Examples 2-1 to 2-14 and Comparative Examples 2-1 to 2-3, the content of calcium carbonate relative to the plasticizer became large, so that there was such a tendency that the slurry viscosities of the mixtures obtained therein were increased as compared to those obtained in Example 1-1 and Comparative Example 1-1.

In addition, the reason why the slurry viscosity of the mixture of the plasticizer and calcium carbonate which was obtained in Comparative Example 2-3 was considerably large as compared to the slurry viscosity of the halogen-based resin composition obtained in Comparative Example 1-1 is considered to be that the content of calcium carbonate in the mixture of Comparative Example 2-3 was so large as to form a network structure of calcium carbonate in the plasticizer, whereas the content of calcium carbonate in the halogen-based resin composition of Comparative Example 1-1 was relatively small, so that the calcium carbonate was inhibited from forming a network structure thereof to such an extent that the slurry viscosity of the resulting halogen-based resin composition was considerably increased.

From the results of Example 2-2 in which the polymer dispersant 2 having a degree of neutralization of 20 mol % was used and Comparative Example 2-1 in which the polymer dispersant 5 having a degree of neutralization of 50 mol % was used, it was confirmed that as long as the degree of neutralization of the polymer dispersant was below a predetermined level, the halogen-based resin composition containing such a polymer dispersant showed a reduced slurry viscosity, and was improved in processability. Since the degree of neutralization of the surfactant described in the Patent Literature 1 is not less than 80 mol %, it is considered that the resulting halogen-based resin composition fails to reduce a slurry viscosity thereof to a sufficient extent similarly to the results of Comparative Example 2-1. Also, it is considered that since the surfactant described in the Patent Literature 1 is in a crosslinked state, a molecular weight of the surfactant is very large. In Comparative Example 2-2, there was used the polymer dispersant 6 having a large weight-average molecular weight, so that the halogen-based resin composition obtained therein failed to reduce a slurry viscosity thereof. In consequence, it is considered that the surfactant described in the Patent Literature 1 also fails to reduce a slurry viscosity of the obtained halogen-based resin composition.

In Examples 2-3, 2-6, 2-8 to 2-12 and 2-14 using the polymer dispersants produced in Production Examples 3, 8, 11 to 15 and 17, respectively, the slurry viscosities of the mixtures obtained therein were low. Therefore, it is considered that the halogen-based resin compositions obtained using these mixtures suffer from extremely low or no bleed-out of the polymer dispersants.

### [Low-Temperature Flex Resistance Test of Halogen-Based Resin Composition]

### Example 3-1

### (Production of Halogen-Based Resin Composition)

The polymer dispersant 3 in an amount of 0.1 g (corresponding to 0.5% in terms of a concentration of the polymer dispersant relative to a mass of calcium carbonate), 60 g of a plasticizer “VINYCIZER 124N” (dialkyl (C₁₀ to C₁₂) phthalate) available from Kao Corporation, 20 g of calcium carbonate “WHITE H” (tradename) available from Shiraishi Calcium Kaisha Ltd., 100 g of a vinyl chloride resin “ZEST1400” (tradename; average polymerization degree: 1400) available from Shin Dai-Ichi Vinyl Corporation, 2 g of a Ca/Mg/Zn-based stabilizer for vinyl chloride resins “ADEKA STAB RUP-103” (tradename) available from ADEKA Corporation and 0.5 g of a lubricant “LUNAC S-70V” (tradename) available from Kao Corporation were mixed with each other at room temperature using a stirring rod. Thereafter, the resulting mixture was mixed and gelled at a rotating speed of 17.5 rpm at 160° C. using a 4-inch open roll-type kneader available from Nishimura Machinery Co., Ltd., followed by continuously mixing the mixture for 10 minutes after the gelling, thereby obtaining a halogen-based resin composition.

### (Production of Molded Sheet)

The halogen-based resin composition obtained above was preheated at 170° C. for 5 minutes, and then pressed under a pressure of 20 MPa for 2 minutes, thereby obtaining a resin molded sheet having a thickness of 0.8 mm.

### (Method for Evaluation of Low-Temperature Flex Resistance)

The molded sheet of the halogen-based resin composition obtained above was punched and formed into 6 test pieces each having a size of 6 mm×64 mm. The respective test pieces were subjected to a low-temperature flex resistance test using a De Mattia flex cracking tester “FT-1506” (tradename) available from Ueshima Seisakusho Co., Ltd. The low-temperature flex resistance test was carried out under the conditions of a testing temperature of −25° C., a flexing speed (flex frequency) of 300 times/min, a distance between clamps of 30 mm and a flex stroke of 25 mm. The test was stopped every 1000 times of the flex frequency to confirm whether or not any breakage occurred on the respective test pieces, and measure the flex frequency required until reaching the breakage of each of the 6 test pieces. Each value shown in the column “Flex frequency up to breakage” in Table 5 is an average of four values remaining after excluding maximum and minimum values from the 6 flex frequency values of the 6 test pieces which were measured for the flex frequency required until reaching their breakage. The larger the flex frequency average value became, the more excellent the low-temperature flex resistance of the halogen-based resin composition was.

### Examples 3-2 to 3-4

The same procedure as in Example 3-1 was repeated except that the kind of polymer dispersant was changed to those shown in Table 5, thereby obtaining molded sheets of halogen-based resin compositions and evaluating low-temperature flex resistance of the respective molded sheets. The results are shown in Table 5.

### Comparative Example 3-1

The same procedure as in Example 3-1 was repeated except that no polymer dispersant 3 was used, thereby obtaining a molded sheet of a halogen-based resin composition and evaluating low-temperature flex resistance of the molded sheet. The results are shown in Table 5.

TABLE 5

| | | Polymer dispersant | | Evaluation results |
|---|---|---|---|---|
| | | | Concentration | Flex frequency up to |
| | | Kind | (% by mass)*¹ | breakage (times) |
| Examples | 3-1 | 3 | 0.5 | 13,250 |
| | 3-2 | 8 | 0.5 | 14,400 |
| | 3-3 | 11 | 0.5 | 15,750 |
| | 3-4 | 12 | 0.5 | 12,600 |
| Comparative | 3-1 | — | — | 10,750 |
| Example | | | | |

*¹Concentration of the polymer dispersant relative to a mass of calcium carbonate

From the results of Examples 3-1 to 3-4 and Comparative Example 3-1, it was confirmed that by using the polymer dispersants, the resulting halogen-based resin compositions were improved in low-temperature flex resistance.

### [Measurement of Slurry Viscosity of Mixture Obtained by Collectively Adding Respective Components at One Time]

### Example 4-1

The same procedure as in Example 2-8 was repeated except that the plasticizer was replaced with a trimellitate (tris(2-ethylhexyl) trimellitate) available from Tokyo Chemical Industry Co., Ltd., thereby preparing a mixture, and the slurry viscosity of the thus prepared mixture was measured at 25° C. The results are shown in Table 6.

### Example 4-2

The same procedure as in Example 2-10 was repeated except that the plasticizer was replaced with the aforementioned trimellitate, thereby preparing a mixture, and the slurry viscosity of the thus prepared mixture was measured at 25° C. The results are shown in Table 6.

### Comparative Example 4-1

The same procedure as in Comparative Example 2-3 was repeated except that the plasticizer was replaced with the aforementioned trimellitate, thereby preparing a mixture, and the slurry viscosity of the thus prepared mixture was measured at 25° C. The results are shown in Table 6.

TABLE 6

| | |
|---|---|
| | Evaluation |
| Polymer dispersant | results |

| | | | Concentration | Slurry viscosity |
|---|---|---|---|---|
| | | Kind | (% by mass)*¹ | (Pa · s) |
| Examples | 4-1 | 11 | 0.5 | 10.4 |
| | 4-2 | 13 | 0.5 | 18.6 |
| Comparative | 4-1 | None | — | 359.8 |
| Example | | | | |

*¹Concentration of the polymer dispersant relative to a mass of calcium carbonate

From the results of Examples 4-1 and 4-2 and Comparative Example 4-1, it was confirmed that even in the case where the trimellitic acid triester was used as the plasticizer, it was possible to reduce the slurry viscosities of the obtained mixtures each composed of the polymer dispersant, the plasticizer and the basic inorganic filler, so that the resulting halogen-based resin compositions were improved in processability.

Incidentally, the reason why the slurry viscosities of the mixtures obtained in Examples 4-1 and 4-2 were higher than the slurry viscosities of the mixtures obtained in Examples 3-11 and 3-14 is considered to be that the viscosity of the trimellitate as the plasticizer is higher than the viscosity of bis(2-ethylhexyl) phthalate.

### [Color Fastness Test for Halogen-Based Resin Composition]

### Example 5-1

### (Production of Molded Sheet)

The halogen-based resin composition obtained in Example 3-4 was preheated at 170° C. for 5 minutes, and then pressed under a pressure of 20 MPa for 2 minutes, thereby obtaining a resin molded sheet having a thickness of 0.8 mm.

### (Method for Evaluation of Color Change)

The molded sheet of the halogen-based resin composition obtained above was subjected to measurement of L*a*b* using a colorimeter “eXact” (tradename) available from Videojet X-Rite K.K., under the conditions of Illuminant D50 and a standard measurer 2°. The smaller absolute value of b* indicates a less color change towards yellow. The results are shown in Table 7.

### Example 5-2

The same procedure as in Example 3-4 was repeated except that the concentration of the polymer dispersant 12 was changed to that shown in Table 7, thereby producing a halogen-based resin composition, and then the same procedure as in Example 5-1 was repeated except that the thus produced halogen-based resin composition was used, thereby producing a molded sheet of the halogen-based resin composition and evaluating its color change towards yellow. The results are shown in Table 7.

### Comparative Example 5-1

The same procedure as in Example 5-1 was repeated except that the halogen-based resin composition produced in Comparative Example 3-1 was used, thereby producing a molded sheet of the halogen-based resin composition and evaluating its color change towards yellow. The results are shown in Table 7.

TABLE 7

| | | Polymer dispersant 12 | | |
|---|---|---|---|---|
| | | Concentration | Concentration | Evaluation |
| | | (% by mass)*¹ | (% by mass)*² | b* |
| Examples | 5-1 | 0.5 | 0.05 | −1.56 |
| | 5-2 | 5 | 0.5 | −0.41 |
| Comparative | 5-1 | — | — | −1.88 |
| Example | | | | |

*¹Concentration of the polymer dispersant relative to a mass of calcium carbonate
*²Concentration of the polymer dispersant relative to the halogen-based resin composition

From the results of Examples 5-1 and 5-2 and Comparative Example 5-1, it was confirmed that by using the polymer dispersants, it was possible to inhibit the resulting halogen-based resin compositions from suffering from color change towards yellow. In addition, from the results of Examples 5-1 and 5-2, it was confirmed that by increasing the amounts of the polymer dispersants used, it was possible to further inhibit the resulting halogen-based resin compositions from suffering from color change towards yellow.

### INDUSTRIAL APPLICABILITY

In accordance with the present invention, it is possible to provide a halogen-based resin composition that is improved in processability by reducing a slurry viscosity thereof. The halogen-based resin composition of the present invention is useful as housing interior products, such as adhesives, sealants, paints, plastisol, foamed bodies, synthetic leather, pipes such as water pipes, etc., building materials, wall paper materials, floorings, floor covering materials, insulating materials, roof membrane materials, etc.; packaging materials, such as food packaging films, etc.; agricultural materials, such as agricultural films, etc.; automotive materials, such as sealing materials, undercoat materials, etc.; substrate protecting materials; cloth covering materials; sheathing materials for electric cables; various leather products; various foamed products; general-purpose hoses; gaskets; packing; boots; toys; food packaging materials; medical products, such as tubes, blood bags, etc.; and the like.

1. A halogen-based resin composition comprising a plasticizer, a polymer dispersant, a basic inorganic filler and a halogen-based resin, in which:
the polymer dispersant comprises a carboxy group-containing constitutional unit and a hydrophobic group-containing constitutional unit;
a degree of neutralization of the polymer dispersant is not more than 30 mol %;
a weight-average molecular weight (Mw) of the polymer dispersant is not less than 4,000 and not more than 200,000; and
a mass ratio of the polymer dispersant to the basic inorganic filler is not less than 0.0005 and not more than 0.1.

2. The halogen-based resin composition according to claim 1, wherein the halogen-based resin comprises at least one resin selected from the group consisting of a vinyl chloride resin, a vinylidene chloride resin and a chloroprene rubber.

3. (canceled)

4. The halogen-based resin composition according to claim 1, wherein the basic inorganic filler comprises calcium carbonate.

5. The halogen-based resin composition according to claim 1, wherein the basic inorganic filler is calcium carbonate.

6. The halogen-based resin composition according to claim 1, wherein a content of the plasticizer in the halogen-based resin composition is not less than 10 parts by mass and not more than 170 parts by mass on the basis of 100 parts by mass of the halogen-based resin.

7. The halogen-based resin composition according to claim 1, wherein a content of the basic inorganic filler in the halogen-based resin composition is not less than 1 part by mass and not more than 150 parts by mass on the basis of 100 parts by mass of the halogen-based resin.

8. The halogen-based resin composition according to claim 1, wherein a content of the polymer dispersant in the halogen-based resin composition is not less than 0.001% by mass and not more than 0.8% by mass.

9. The halogen-based resin composition according to claim 1, wherein the polymer dispersant comprises a constitutional unit derived from an α,β-unsaturated carboxylic acid as the carboxy group-containing constitutional unit, and a constitutional unit derived from at least one compound selected from the group consisting of an ester of an α,β-unsaturated carboxylic acid, an amide of an α,β-unsaturated carboxylic acid, a styrene-based compound, and C₃ to C₁₀ linear or branched alkene as the hydrophobic group-containing constitutional unit.

10. The polymer dispersant according to claim 1, wherein a content of the carboxy group-containing constitutional unit in the polymer dispersant, provided that the content of the whole constitutional units therein is 100% by mass, is not less than 1% by mass and not more than 50% by mass.

11. The polymer dispersant according to claim 1, wherein the weight-average molecular weight of the polymer dispersant is not less than 5,000 and not more than 20,000.

12. The dispersant according to claim 1, wherein the acid value of the polymer dispersant is not less than 30 mgKOH/g and not more than 150 mgKOH/g.

13. The dispersant according to claim 1, wherein the polymer dispersant is in an unneutralized state.

14. The halogen-based resin composition according to claim 1, wherein a mass ratio of the polymer dispersant to the basic inorganic filler is not less than 0.002 and not more than 0.01.

15. The halogen-based resin composition according to claim 1, wherein the halogen-based resin is a vinyl chloride resin.

16. The halogen-based resin composition according to claim 1, wherein the SP value of the plasticizer is not less than 7.5 (cal/cm³)^{1/2} and not more than 11.5 (cal/cm³)^{1/2}.

17. The halogen-based resin composition according to claim 1, wherein the plasticizer is a phthalic acid ester of a C₈ to C₁₃ alcohol or a trimellitic acid ester of a C₈ to C₁₃ alcohol.

18. A polymer dispersant comprising a carboxy group-containing constitutional unit and a hydrophobic group-containing constitutional unit, wherein
a degree of neutralization of the polymer dispersant is not more than 30 mol %; and
a weight-average molecular weight (Mw) of the polymer dispersant is not less than 4,000 and not more than 200,000.

19. A method for improving low-temperature flex resistance of the polymer dispersant according to claim 18, wherein the method comprises adding the polymer dispersant to a composition comprising a plasticizer, a basic inorganic filler, and a halogen-based resin.

20. A method for improving processability of the polymer dispersant according to claim 18, wherein the method comprises adding the polymer dispersant to a composition comprising a plasticizer, a basic inorganic filler, and a halogen-based resin.
